(19) United States
(12) Patent Application Publication
(10) Pub. No.: US 2005/0084267 A1
(43) Pub. Date: Apr. 21, 2005

(54) Performance enhanced single-hop WDM network with heterogeneous protection

(75) Inventors: Chun Fan, Tempe, AZ (US); Martin Maier, Berlin (DE); Martin Reisslein, Tempe, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(73) Assignees: ARIZONA BOARD OF REGENTS, a body corporate of the State of Arizona, acting for and on behalf of; ARIZONA STATE UNIVERSITY

(21) Appl. No.: 10/938,340

(22) Filed: Sep. 9, 2004

Related U.S. Application Data
(60) Provisional application No. 60/501,782, filed on Sep. 9, 2003.

(51) Int. Cl. H04J 14/02

(52) U.S. Cl. 398/84

(57) ABSTRACT

A novel single-hop WDM network, the AWG∥PSC network, comprises an AWG in parallel with a PSC. The AWG and PSC provide heterogeneous protection for each other; the AWG∥PSC network remains functional when either the AWG or the PSC fails. If both AWG and PSC are functional, the AWG∥PSC network uniquely combines the respective strengths of the two devices. The throughput of the AWG∥PSC network is significantly larger than the total throughput obtained by combining the throughput of a stand-alone AWG network with the throughput of a stand-alone PSC network. The AWG∥PSC network provides, over a wide operating range, a better throughput-delay performance than a network consisting of either two load sharing PSCs in parallel or two load sharing AWGs in parallel.

### RELATED APPLICATION DATA

This application is based on and claims the benefit of U.S. Provisional Patent Application No. 60/501,782 filed on Sep. 9, 2003, the disclosure of which is incorporated herein in its entirety by this reference.

### BACKGROUND OF THE INVENTION

This invention relates to communications networks. More particularly, it relates to a novel single-hop wavelength division multiplexing (WDM) network comprising an arrayed-waveguide grating (AWG) in parallel with a passive star coupler (PSC).

Single-hop WDM networks based on a central Passive Star Coupler (PSC) or Arrayed-Waveguide Grating (AWG) hub have received a great deal of attention as promising solutions for the quickly increasing traffic in metropolitan and local area networks. Single-hop WDM networks have attracted a great deal of attention due to their minimum hop distance, high bandwidth efficiency (no bandwidth is wasted due to packet forwarding as opposed to their multi-hop counterparts), and inherent transparency. Single-hop networks come in two types: broadcast networks and switched networks. In the 1990's much research was focused on the design and evaluation of MAC protocols for single-hop WDM networks that are based on a passive star coupler (PSC). See, for instance, B. Mukherjee [1]. These networks form broadcast networks in which each wavelength is distributed to all destination nodes. Recently, arrayed-waveguide grating (AWG) based single-hop networks have attracted much interest, such as in references [2]-[5], all of which are incorporated herein in their entirety by this reference. By using a wavelength-routing AWG instead of a PSC as central hub, each wavelength is not broadcast but routed to a different AWG output port resulting in switched single-hop networks. These switched single-hop networks allow each wavelength to be used at all AWG input ports simultaneously without resulting in channel collisions at the AWG output ports. The resulting spatial wavelength reuse dramatically improves the throughput-delay performance of single-hop networks, as explained in more detail by M. Maier, M. Scheutzow, M. Reisslein, and A. Wolisz [6].

Given the ever-increasing traffic amount due to higher line rates, larger wavelength counts, and spatial wavelength reuse, protection becomes paramount. Specifically, single-hop network operation is immune from node failures since nodes do not have to forward traffic. But all single-hop networks—either PSC or AWG based—suffer from a single point of failure: if the central hub fails the network connectivity is entirely lost due to missing alternate paths. This holds also for all multi-hop networks whose logical topology is embedded on a physical single-hop network. Therefore, protection of (physical) single-hop networks is required to ensure survivability.

Protection of single-hop networks has received only little attention so far. See A. Hill, et al. [7]; Y Sakai, et al. [8]. While the passive nature of the PSC and AWG makes the network fairly reliable, it does not eliminate the inherent single point of failure. Two protection options that come to mind are conventional 1+1 or 1:1 protection. In these cases, the network would consist of two PSCs or two AWGs in parallel. This type of (homogeneous) protection is rather inefficient: While in the 1+1 protection the backup device is used to carry duplicate data traffic, in the 1:1 protection the backup device is not used at all during normal operation.

It is an object of the present invention to provide a single-hop WDM network that efficiently addresses the single point of failure described above.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, there is provided a single-hop WDM network having a novel protection scheme. In a presently preferred embodiment, the network comprises an AWG and a PSC in parallel, which we call the AWG∥PSC network. Under normal operation, i.e., where both the AWG and PSC are functional, the AWG∥PSC network uniquely combines the respective strengths of both devices and provides heterogeneous protection in case either device fails. The AWG∥PSC network enables highly efficient data transport by (i) spatially reusing all wavelengths at all AWG ports, and (ii) using those wavelengths continuously for data transmission.

According to one aspect of the invention, nodes are coupled to the central AWG with one tunable transmitter and one tunable receiver. Both the transmitter and receiver are tunable in order to guarantee any-to-any connectivity in one single hop. In such a highly flexible environment where both transmitter and receiver are tunable, wavelength access is typically controlled by reservation protocols. See M. Maier, M. Reisslein, and A. Wolisz [9] and the references therein. That is, prior to transmitting a given data packet the source node sends a control packet to inform the corresponding destination node. To do this efficiently, in the presently preferred network of the invention each node is equipped with an additional transmitter/receiver pair, which is attached to the PSC and broadcasts control packets (reservation requests) over the PSC. After one end-to-end propagation delay (i.e., half the round-trip time) each node knows the outcome of its reservation and also acquires global knowledge, which is used in a distributed common scheduling algorithm. Besides broadcasting control information the PSC is used to transport “overflow” data traffic, which cannot be accommodated on the AWG.

According to another aspect of the invention, MAC protocols are provided for the three different operating modes: (i) “both AWG and PSC functional” (A WG-PSC mode), (ii) “PSC failed” (A WG-only mode), and (iii) “AWG failed” (PSC-only mode). We find that the throughput of a stand-alone AWG network plus the throughput of a stand-alone PSC network is significantly smaller than the throughput of the AWG∥PSC network in the AWG-PSC mode. Moreover, over a wide operating range the AWG∥PSC network achieves a better throughput-delay performance than a network consisting of either two load sharing PSCs in parallel or two load sharing AWGs in parallel.

### DESCRIPTION OF THE DRAWINGS

The accompanying drawings, which are incorporated in and constitute a part of the specification, illustrate the presently preferred embodiments and methods of the invention and, together with the general description given above and the detailed description of the preferred embodiments and methods given below, serve to explain the principles of the invention.

FIG. 1 illustrates the wavelength reuse and periodic routing properties of an AWG.

FIG. 2 shows the architecture of an embodiment of a network according to the present invention.

FIG. 3 depicts the nodal architecture of the network of FIG. 2.

FIG. 4 shows the wavelength assignment and timing structure of the AWG∥PSC network in the AWG-PSC mode.

FIG. 5 shows the PSC-only mode frame structure for the AWG∥PSC network.

FIG. 6 depicts the AWG-only mode control packet transmission cycle and the frame structure for the AWG∥PSC network.

FIG. 7 shows the node status based on the transceiver functional status for the AWG∥PSC network.

FIG. 8 shows the transmission matrix based on node transceiver status for the AWG∥PSC network.

FIG. 9 shows plots of the throughput-delay performance of the AWG∥PSC network for different AWG degrees.

FIG. 10 shows plots of the throughput-delay performance of the AWG PSC network for different numbers of used FSRs.

FIG. 11 shows plots of the throughput-delay performance of the AWG∥PSC network for a fixed number of wavelengths in the network (Λ=8) and different combinations of D and R with D·R=8.

FIG. 12 shows plots of the throughput-delay performance of the AWG∥PSC network in the four modes: PSC-only mode, AWG-only mode without wavelength reuse (i.e., a scheduling window of one frame), AWG-only mode with wavelength reuse (i.e., a scheduling window of one cycle), and AWG-PSC mode.

FIG. 13 shows comparative plots of the throughput-delay performance of the AWG∥PSC network, a PSC∥PSC network (consisting of two PSCs in parallel) and an AWG∥AWG network (consisting of two AWGs in parallel).

FIG. 14 shows comparative plots of the throughput-delay performance for three networks: a D-buffered AWG∥AWG network with one control; a D-buffered AWG∥AWG network with two controls; and the AWG∥PSC network.

FIG. 15 shows comparative plots of throughput-delay performance of the AWG∥PSC network for three modes of operation for self-similar traffic and large node buffers.

FIG. 16 is an illustration of time-sequenced buffering.

FIG. 17 shows comparative plots of the throughput-delay performance for AWG∥PSC, AWG∥AWG, and PSC∥PSC networks for a one-way end-to-end propagation delay of τ=4 frames.

FIG. 18 shows comparative plots of the throughput-delay performance for AWG∥PSC, AWG∥AWG, and PSC∥PSC networks for a one-way end-to-end propagation delay of τ=16 frames.

FIG. 19 shows comparative plots of the throughput-delay performance for AWG∥PSC, AWG∥AWG, and PSC∥PSC networks for a one-way end-to-end propagation delay of τ=96 frames.

### DETAILED DESCRIPTION OF THE INVENTION

### I. Introduction

This specification is organized as follows. In the following subsection, we review related work. In Section II we briefly describe the properties of the AWG and the PSC. In Section III we describe the architecture of the AWG∥PSC network. In Section IV we develop MAC protocols for the three operating modes of the AWG∥PSC network. In Section V we develop a probabilistic model of the network and analyze the throughput and delay performance of the three operating modes. In Section VI we use our analytical results to conduct numerical investigations. We also verify our analytical results with simulations. We summarize our conclusions in Section VII.

A. Related Work

Single-hop networks based on one PSC as the central broadcasting device have been studied extensively since WDM technology was first proposed for optical networks. References [1], [10], [11], [12], [13], [14], [15], [16], [17], [18], [19], [20], [21] represent a sample of the numerous proposals of MAC protocols and analysis of throughput-delay performance associated with various PSC based network architectures. The main constraint of using one PSC is that each wavelength provides only one communication channel between a pair of nodes at any one instance in time. However, wavelengths are precious in metropolitan and local area networks due to cost considerations and tunable transceiver limitations.

One of the ways to increase the transmission efficiency, i.e., to increase capacity without increasing the number of wavelengths, is to reuse the same set of wavelengths in the network. A number of strategies have been examined over the years. Kannan et al. [22] introduce a two level PSC star so that the same set of wavelengths can be reused in each star cluster. Janoska and Todd [23] propose a hierarchical arrangement of linking multiple local optical networks to a remote optical network. Chae et al. [24] use an AWG to link multiple PSC networks in series. Again, the same set of wavelengths are reused in each star cluster. Banerjee et al. [25] and Glance et al. [26] outline network architectures based on AWG routers for wavelength reuse. Bengi [27] studies the scheduling in LAN architectures based on a single AWG or a single PSC.

According to the present invention, we describe a novel AWG∥PSC network to address the single point of failure in single-hop WDM networks. To our knowledge, only Hill et al. [7] and Sakai et al. [8] have previously considered this issue. In the work by Hill et al. the central hub of the single-hop WDM network consists of r working AWGs, which are protected by n identical standby AWGs. These standby wavelength routers are activated only in case of failure, thus implementing a conventional homogeneous n:r protection scheme. Sakai et al. [8] study a dual-star structure where two AWGs back up each other in 1:1 fashion. Our work differs from Hill et al. [7] and Sakai et al. [8] in that we propose a heterogeneous protection scheme that efficiently benefits from the respective strengths of AWG and PSC and uses both devices under normal operation.

The operation of the network according to our invention is different from the parallel processing network described by Arthurs et al. [28], which consists of two PSCs. In Arthurs et al. [28], one PSC is used for data transmission and the other PSC is used for data reception. In case of PSC failure, data transmission or/and reception is impossible due to missing protection. In terms of network architecture, we do not divide the nodes into subnetworks as proposed in B. Kannan, et al. [22], M. Janoska, et al. [23] and C. J. Chae, et al. [24]. In the network architecture according to our invention, all of the nodes are connected directly to the AWG as one network, similar to that described by N. E Caponio, et al. [2], M. Maier, M. Reisslein, and A. Wolisz[4], M. Maier, M. Scheutzow, M. Reisslein, and A. Wolisz [6] and B. Glance, et al. [29]. In the network architecture of the present invention, however, all of the nodes are also connected to a PSC, which provides effective broadcast features for control packets. We demonstrate that the broadcast capability of the PSC eliminates the cyclic control packet transmission delays of stand-alone AWG networks, thus achieving high bandwidth efficiency at lower delays.

### II. Properties of PSC and AWG

The passive star coupler (PSC) is a passive broadcasting device. In an N×N PSC, a signal coming from any input port is equally divided among the N output ports. The theory and construction of the PSC are described in more detail by A. Saleh and H. Kogelnik, [30] and M. Tabiani and M. Kavehrad [31]. The broadcast property of the PSC makes it an ideal device for distributing information to all nodes in WDM networks. Star topology networks based on the PSC as the central broadcast device require a lower power budget compared to networks with a linear bus topology or a tree topology. These advantages have led to numerous proposals for PSC-based broadcast-and-select networks, such as described above in Section I-A. In these networks the dynamic wavelength allocation is controlled by a media access control (MAC) protocol. Chipalkatti et al. [11] and Mukherjee [1] provide surveys and network performance comparisons for different categories of MAC protocols.

The drawback of a PSC network is its lack of wavelength efficiency because each wavelength can only be used by one input port at a time. A collision occurs if a wavelength is used by more than one input port at the same time, resulting in a corrupted signal. Since each wavelength provides exactly one channel between a source-destination pair, expanding the transmission capacity of a PSC network requires more wavelengths. Also, broadcasting information to unintended nodes may lead to added processing burden for the nodes.

The arrayed-waveguide grating (AWG) is a passive wavelength-routing device. The construction and the properties of the AWG are discussed in more detail by C. Dragone [32], [33]. B. Glance, et al. [29], Y Hibino [34], K. McGreer [35] and Y. Tachikawa, et al. [36] discuss the application of the AWG in multiplexing, demultiplexing, add-drop multiplexing, and routing. In a preferred embodiment of the AWG∥PSC network of our invention, we use the AWG as a router. The crosstalk performance of AWG routers and the feasibility of AWG routers have been studied extensively. See, for instance, P. Bernasconi, C. Doerr, C. Dragone, and M. C. et al. [37].

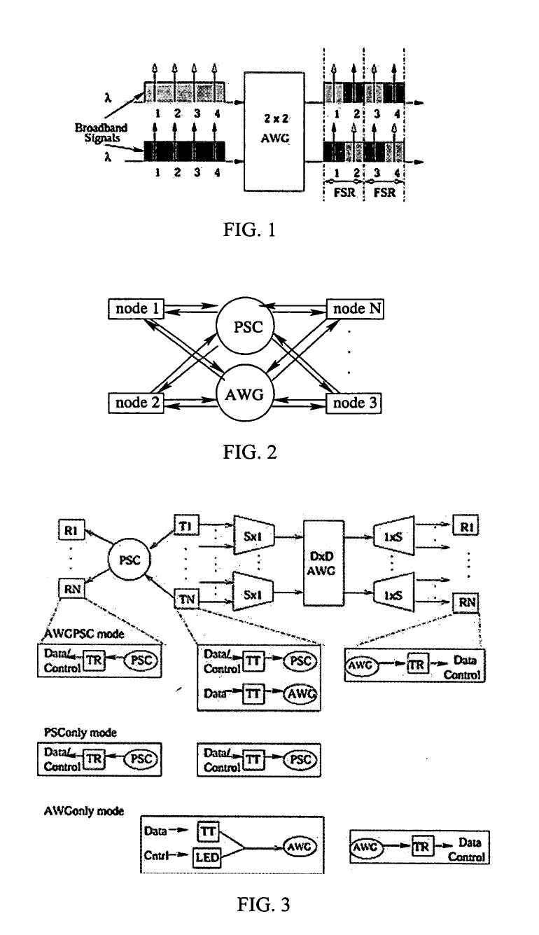

FIG. 1 illustrates the wavelength reuse and periodic routing properties of the AWG. As shown in FIG. 1, four wavelengths are simultaneously applied at both input ports of a 2×2 AWG. The AWG routes every second wavelength to the same output port. This period of the wavelength response is referred to as free spectral range (FSR). FIG. 1 shows two FSRs, allowing two simultaneous transmissions between each AWG input-output port pair. From FIG. 1, we also see that in order for a signal from one input port to reach all of the output ports at the same time, a multi-wavelength or broadband light source is required.

In the network of our invention, we exploit two features of the AWG: (i) wavelength reuse, and (ii) periodic wavelength routing in conjunction with utilizing multiple FSRs. Wavelength reuse allows the same wavelengths to be used simultaneously at all of the AWG input ports. So, with a D×D AWG (D input ports and D output ports), each wavelength can be reused D times. Periodic wavelength routing and the utilization of multiple FSRs allow each input-output port pair to be connected by multiple wavelengths. We let R denote the number of utilized FSRs. Hence, Λ=D·R wavelengths are used at each AWG port.

The number of nodes N in a metropolitan or local area network is typically larger than D. Combiners are used to connect groups of transmitters to the input ports of the AWG and splitters are used to connect groups of receivers to the output ports of the AWG. With a given number of nodes, there is more than one way to construct a network by varying the parameters of the AWG and the combiners/splitters. For example, we can connect 16 nodes to a 4×4 AWG using four 4×1 combiners and four 1×4 splitters. Or, we can connect the 16 nodes using a 2×2 AWG and two 8×1 combiners and two 1×8 splitters. With, say, Λ=4 wavelengths, the first case results in one wavelength channel per input-output port pair, i.e., R=1. The second case results in two wavelength channels per input-output port pair, i.e., R=2. In Section VI below, we compare the throughput and delay performance of the network for different configurations of R and D.

### III. Architecture

FIG. 2 shows the preferred architecture of the AWG∥PSC network according to the present invention. The PSC and the AWG operate in parallel. FIG. 3 depicts the nodal architecture detail. In star networks without redundant fiber back-up, each node is connected by one pair of fibers, one for the transmission of data, and one for the reception of data. In a network according to our invention, we deploy one-to-one fiber back-up for improved path protection and survivability, that is, each node is connected to the AWG∥PSC network by two pairs of fibers.

As shown in FIG. 2, each node is equipped with two fast tunable transmitters (TT), two fast tunable receivers (TR), each with a tuning range of Λ=R·D wavelengths, and one off-the-shelf broadband light emitting diode (LED). Due to the extensive spatial wavelength reuse, the tuning range (number of wavelengths) can be rather small. This allows for deploying electro-optic transceivers with negligible tuning times. One TT and one TR are coupled directly to one of the PSC's input ports and output ports, respectively. The TT and TR coupled to the PSC are referred to herein as PSC TT and PSC TR, respectively. The second TT and TR are coupled to one of the AWG's input ports and output ports via an S×1 combiner and a 1×S splitter, respectively. These are referred to herein as AWG TT and AWG TR. We note that an alternative architecture to the PSC TT-TR is to equip each node with a tunable PSC transmitter and two fixed-tuned PSC receivers, one tuned to the node's home channel and the other tuned to the control channel. The drawback of this architecture is the lack of data channel flexibility resulting in inefficient channel utilization. In addition, with our approach all wavelength channels can be used for data transmission, whereas with a fixed control channel one wavelength is reserved exclusively for control. Studies by J. Lu and L. Kleinrock [18] and K. M. Sivalingam [38] have shown that, by allowing a node to receive data on any free channel, the TT-TR architecture has smaller delays and higher channel utilizations compared to the TT-FR architecture.

The LED is coupled to the AWG's input port via the same S×1 combiner as the AWG TT. The LED is used for broadcast of control packets by means of spectral slicing over the AWG when the network is operating in AWG-only mode (discussed in more detail in Section IV below). Two pairs of TTs and TRs allow the nodes to transmit and receive packets over the AWG and the PSC simultaneously. This architecture also enables transceiver back-up for improved nodal survivability.

### IV. MAC Protocols

We now describe preferred MAC protocols for the normal operating mode as well as the various back-up modes. We define two levels of back-up. The first level is the back-up of the central network components, i.e., the PSC or the AWG. Because the AWG and the PSC operate in parallel, the two devices naturally back-up each other. We have three different modes of operation: (i) A WG-PSC mode, with both AWG and PSC functional, (ii) PSC-only mode, with AWG down, and (iii) A WG-only mode, with PSC down. We present the MAC protocols for all three operating modes. The network's throughput and delay performance for each of the three operating modes is examined in Section VI below.

The second level of back-up makes use of the two TT/TR's at each node to enable transceiver back-up at the node level.

A. AWG-PSC Mode

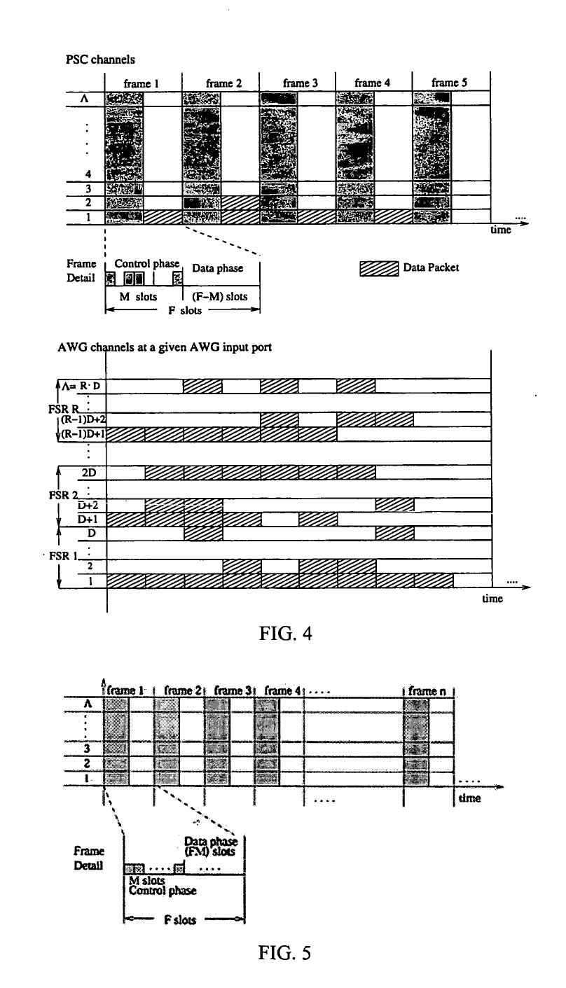

FIG. 4 shows the wavelength assignment and timing structure for the AWG-PSC mode. With a transceiver tuning range of Λ wavelengths, the PSC provides a total of Λ wavelength channels. The length of a PSC frame is F slots. The slot length is equal to the transmission time of a control packet (which is discussed shortly). Each PSC frame is divided into a control phase and a data phase. During the control phase, all of the nodes tune their PSC TR to a pre-assigned wavelength. (One of the wavelength channels on the PSC is used as a control channel during the first M slots in a frame; in the remaining slots this channel carries data.)

Given N nodes in the network, if node i, 1≦i≦N, has to transmit a packet to node j, i≠j, 1≦j≦N, node i randomly selects one of the M control slots and transmits a control packet in the slot. The slot is selected using a uniform distribution to ensure fairness. Random control slot selection, as opposed to fixed reservation slot assignment, also makes the network upgradable without service disruptions and scalable.

The nodes transmit their data packets only after knowing that the corresponding control packets have been successfully transmitted and the corresponding data packets successfully scheduled. All nodes learn of the result of the control channel transmission after the one-way end-to-end propagation delay (i.e., half the round-trip time). A control packet collision occurs when two or more nodes select the same control slot. A node with a collided control packet enters the backlog state and retransmits the control packet in the following frame with probability p.

The control packet contains three fields: destination address, length of the data packet, and the type of service. Defining the type of service enables circuit-switching. Once a control packet requesting a circuit is successfully scheduled, the node is automatically assigned a control slot in the following frame. This continues until the node releases the circuit and the control slot becomes available for contention.

A wide variety of algorithms can be employed to schedule the data packets (corresponding to successfully transmitted control packets) on the wavelength channels provided by the AWG and the PSC. To avoid a computational bottleneck in the distributed scheduling in the nodes in our very high-speed optical network, the scheduling algorithm preferably should be simple. Therefore, we adopt a first-come-first-served and first-fit scheduling algorithm with a frame timing structure on the AWG. The frames on the AWG are also F slots long, as the PSC frames. However, unlike the PSC frames, the AWG frames are not subdivided into control and data phase. Instead, the entire AWG frame is used for data. With this algorithm, data packets are assigned wavelength channels starting with the earliest available frame on the lowest FSR on the AWG. Once all the FSRs on the AWG are assigned for that frame, assignment starts on the PSC beginning with the lowest wavelength. Once all the AWG FSRs and PSC wavelengths are assigned in the earliest available frame, assignment starts for the next frame, again beginning with the lowest FSR on the AWG, and so forth. This continues until the scheduling window is full. The unassigned control packets are discarded and the nodes retransmit the control packets with probability p in the next frame. A node with a collided control packet or a data packet that did not get scheduled (even though the corresponding control packet was successfully transmitted) continues to retransmit the control packet, in each PSC frame with probability p, until the control packet is successfully transmitted and the corresponding data packet scheduled.

The nodes avoid receiver collision by tuning their PSC TR to the pre-assigned control wavelength during the control phase of each frame and executing the same wavelength assignment (scheduling) algorithm. Each node maintains the status of all the receivers in the network. Also, since both the PSC TR and the AWG TR may receive data simultaneously, in the case when two data packets are addressed to the same receiving node in the same frame, the receivers may be scheduled for simultaneous reception of data from both transmitting nodes. In case there are more than two data packets destined to the same receiving node, transmission for the additional packet(s) has to be scheduled for future frame(s).

We consider unicast traffic throughout this specification. The AWG∥PSC network according to our invention, however, also provides a flexible infrastructure for efficient multicasting. A multicast with receivers at only one AWG output port can be efficiently conducted over the AWG, with the splitter distributing the traffic to all attached receivers. A multicast with receivers at several AWG output ports, on the other hand, might be more efficiently conducted over the PSC (to avoid repeated transmissions to the respective AWG output ports).

B. PSC-only Mode

The presently preferred network of our invention operates in the PSC-only mode when the AWG fails. A node scheduled to receive a data packet over the AWG detects AWG failure if the scheduled data packet fails to arrive after the propagation delay. The node then signals other nodes by sending a control packet in the following frame. The network changes from AWG-PSC mode to PSC-only mode after the successful transmission of this control packet.

FIG. 5 illustrates the frame structure in the PSC-only mode. As illustrated in FIG. 5, each frame has a control phase and a data phase. During the control phase, all of the nodes with data packets transmit their control packets in one of the M slots during the control phase. Nodes with collided packets retransmit their control packets following a back-off schedule similar to that of the AWG-PSC mode. The nodes that have successfully transmitted the control packet are assigned the earliest slot starting with the lowest available wavelength. Once the scheduling window is full, the control packets corresponding to unscheduled data packets are discarded and the corresponding nodes retransmit the control packets with probability p in the following frame.

C. AWG-Only Mode

The presently preferred network of our invention operates in the AWG-only mode when the PSC fails. Since all of the nodes have their PSC TR tuned to the control channel during the control phase of each frame, PSC failure is immediately known by all nodes and the network transitions from AWG-PSC mode to AWG-only mode.

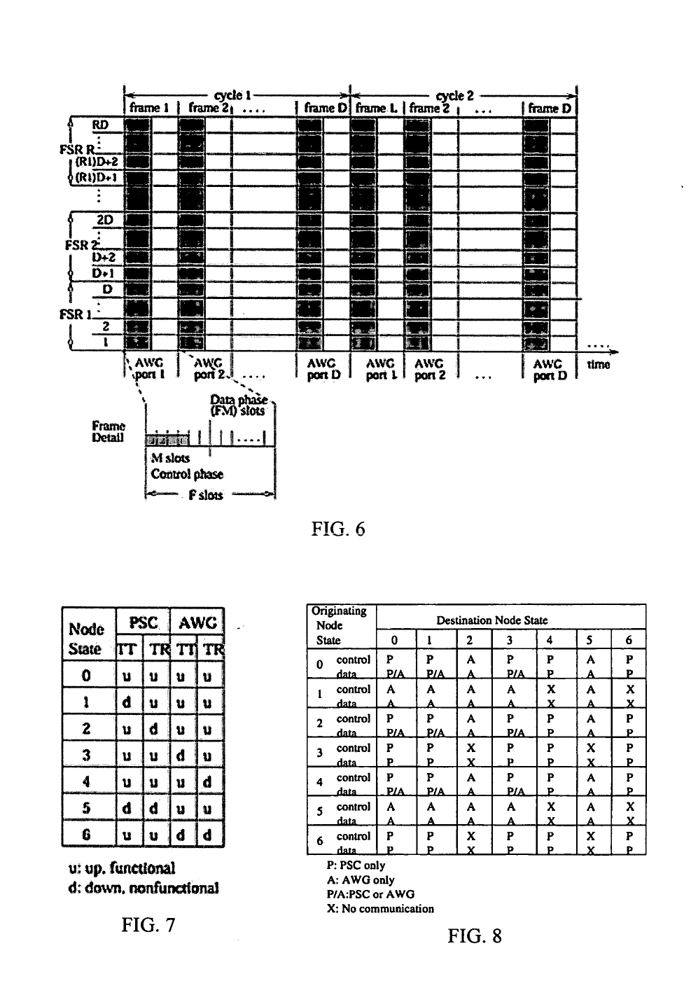

Transmitting and receiving control packets over the AWG are more complicated compared to the PSC. First, recall that a multi-wavelength or a broadband light source is required to transmit a signal from one input port to all output ports (see FIG. 1). Thus, in the AWG-only mode, the LED is used to broadcast the control packets by means of spectral slicing. Second, the transmission of control packets follows a timing structure consisting of cycles to prevent receiver collision of spectral slices. For example (see FIG. 1), if two nodes that are attached to different input ports broadcast control packets using their broadband light source, the wavelength routing property of the AWG slices the signals and sends a slice from each of the broadband signals to each output port. The TR at each node can only pick from one of the wavelengths at each output port to receive the control packet, resulting in receiver collision for the second control packet. Therefore, only the group of nodes attached to the same AWG input port via a common combiner is allowed to transmit control packets in a given frame. In the following frame, the next group of nodes attached to another combiner transmits control packets. This continues until all of the nodes have had a chance to transmit a control packet, and the cycle then starts over. Therefore, with a D×D AWG, a cycle consists of D frames. FIG. 6 depicts the control packet transmission cycle and the frame structure in the AWG-only mode. Methods for frame and cycle synchronization can be readily determined by those of skill in the art (see, for instance, M. Cerisola, T. Fong, R. Hofmeister, et al. [39] and R. Hofmeister, C. Lu, M. Ho, et al [40] for techniques for distributed slot synchronization in WDM networks).

Control packets collide when two or more nodes attached to the same combiner select the same control slot. Nodes with collided control packets retransmit the control packets in the next transmission cycle with probability p.

In the AWG-only mode we distinguish data packet transmission without spatial wavelength reuse and data packet transmission with spatial wavelength reuse. If the scheduling window for data packets is one frame, then nodes can transmit data packets only in one frame out of the D frames in a cycle, which means that there is effectively no wavelength reuse. Full spatial wavelength reuse requires a scheduling window of at least D frames.

D. Transceiver and Fiber Back-Up

In this section, we describe the second level of back-up, the back-up of the nodal transceivers and fibers. We note that generally, nodal transceiver and fiber back-up in single-hop networks are not as critical as in multi-hop networks. This is because a transceiver failure or fiber cut in a single-hop network affects only the traffic originating from or destined to the node with the failed transceiver or fiber cut. In a multi-hop network, on the other hand, a given node has to forward packets that originate from other nodes and are destined to other nodes. Thus, a transceiver failure or fiber cut at one node affects not only the traffic from/to the failed node, but also traffic that originates from other nodes and is destined to other nodes. Nevertheless, nodal transceiver and fiber back-up may be important in certain networking scenarios even in single-hop networks, and the preferred MAC protocol takes advantage of the node architecture to enable transceiver and fiber back-up.

In our network architecture, we denote the fiber connecting the PSC TT of a node to the PSC as the PSC uplink and the fiber connecting the PSC TR of the node to the PSC as the PSC downlink. We denote the fiber connecting the AWG TT and the LED of a node to the AWG as the AWG uplink and the fiber connecting the AWG TR of the node to the AWG as the A WG downlink. Note that the failure of a transmitter or receiver at a node has the same effect as a cut of the corresponding fiber, e.g., a failure of the AWG TT has the same effect as a cut of the AWG uplink. We assume that at any time there is at most one failure in the network, i.e., either the AWG or the PSC fails, or one of the nodes experiences a failure, which is reasonable given the long mean time between failures of the network components.

The failure of any of the transmitters or receivers at a node or a fiber cut can be detected with the techniques developed C.-S. Li and R. Ramaswami [41] and is then signaled to the protection controller, which initiates the transition to the appropriate back-up mode. More specifically, we define six states, illustrated in FIG. 7, where a node with a failed transmitter or receiver or fiber cut can still communicate. Referring to FIG. 7, a transmitter/receiver is considered up if both the transmitter/receiver and the corresponding uplink/downlink are up. A transmitter/receiver is considered down if either the transmitter/receiver or the corresponding uplink/downlink is down (or both are down).

If a node has malfunctions that go beyond the six states, then the node is dropped from the network because the node cannot communicate with other nodes. For example, if a node has a failed PSC TR and a failed AWG TT, then the node cannot transmit control packets over the PSC with its functional PSC TT because the node cannot determine whether the control packets are successful in control packet contention and data packet scheduling (and thus maintain global knowledge in our distributed MAC protocol). Since the AWG TT is down, the node cannot transmit control packets over the AWG and keep track of them with its working AWG TR.

The backup operating modes of our MAC protocol for transceiver and fiber failures are as follows. If a node experiences a failure of its AWG transceiver and/or AWG fibers (i.e., node status 3, 4, or 6) then the network continues operating in the AWG-PSC mode, with some modifications of the scheduling of data packets originating from or destined to the node with the failure. More specifically, if a node has a failure of its AWG TT and/or cut of the AWG uplink fiber (i.e., the node status is 3), then data packets from the node with the failure are only scheduled on the PSC. If the node experiences status 4, then all data packets to the node are scheduled on the PSC. If the node experiences node status 6, then all data packets to and from the node are scheduled on the PSC. If a node experiences a failure of its PSC transceiver and/or PSC fibers (i.e., status 1, 2, or 5), then the network transitions to the AWG-control mode. In the AWG-control mode, control packets are transmitted over the AWG, similar to the AWG-only mode.

Unlike in the AWG-only mode, however, the PSC continues to operate in the AWG-control mode and is used exclusively for data packet transmissions (to and from the nodes that can still transmit and receive over the PSC channels). The data packets from and to the node with the failure are scheduled on the AWG. We briefly note that if either (i) there are two or more nodes that simultaneously experience AWG tranceiver/fiber failure (status 3, 4, or 6), or (ii) there are two or more nodes that simultaneously experience PSC tranceiver/fiber failure (status 1, 2, or 5), then our transceiver and fiber backup scheme still works. However if simultaneously one node experiences status 3, 4, or 6, and another node experiences status 1, 2, or 5, then one of the nodes needs to be dropped from the network because two such nodes cannot communicate with one another while maintaining global knowledge of the ongoing control and data packet transmissions in the network. [Only the combination of a node with status 1 and a node with status 3 could be accommodated at the expense of increased overhead by allowing for the simultaneous transmission of control packets over the PSC (from node with status 3) and the AWG (from node with status 1).] Since any malfunction within the network is usually fixed within a short period of time and the mean time between failures is typically large, the likelihood of dropping a node is fairly small.

### V. Analysis

In this section we develop a probabilistic model for the AWG∥PSC network of our invention.

A. System Model

We make the following assumptions in the modeling of the network according to the present invention and MAC protocols:
Fixed data packet size: Data packets have a fixed size of F/2 slots. Both the control phase and the data phase on the PSC are F/2 slots long, i.e., M=F−M=F/2. On the AWG, each frame accommodates two data packets, as illustrated in FIG. 4. With a degree of D and R utilized FSRs (and a corresponding transceiver tuning range of A=D·R), the AWG provides A wavelength channels at each of its D ports, for a total of D²·R wavelength channels. Thus, the AWG can accommodate at most 2·D²·R data packets per frame.

Uniform unicast traffic: A data packet is destined to any one of the N nodes, including the originating node, with equal probability 1/N. (In our simulations, see Section VI, a node does not transmit to itself. We find that the assumption made in our analytical model that a node transmits to itself with probability 1/N gives very accurate results.)
Scheduling window: The scheduling window is generally one frame. (For the AWG-only mode we consider a scheduling window of one frame as well as a scheduling window of one cycle.) In the AWG-PSC mode and the PSC-only mode, a node with collided control packet or with successfully transmitted control packet but no resources (for data packet scheduling) in the current frame retransmits its control packet in the following frame with probabilityp. In the case of the AWG-only mode, a node with collided control packet or with no transmission resources retransmits in the following cycle with probability P_{A}.
Nodal states and traffic generation: There are two nodal states: idle and backlogged. A node with no data packet in its buffer is defined as idle and generates a new data packet with probability a at the beginning of a frame. Let η denote the number of nodes in this idle state. A node is backlogged if it has (i) a control packet that has failed in the control packet contention, or (ii) a successful control packet but no transmission resources for scheduling the corresponding data packet. The number of backlogged nodes equals N−η. Backlogged nodes retransmit their control packets with probabilityp in a frame. If a node has successfully transmitted a control packet and the corresponding data packet has been successfully scheduled, then the node is considered idle and generates a new packet with probability a in the following frame.
Receiver Collision: We ignore receiver collisions in our analysis. In our simulations in Section VI, on the other hand, we take receiver collisions into consideration. In particular, in the AWG-PSC mode we schedule a data packet on the AWG only if the AWG TR is available. If the AWG TR is busy (or the AWG channels are already occupied), we try to schedule the packet on the PSC. If the PSC TR is busy (or the PSC channels are already occupied), the data packet scheduling fails and the transmitting node retransmits another control packet in the following frame with probability p. In our simulations of the AWG-only mode (PSC-only mode), the data packet scheduling fails if the AWG TR (PSC TR) is busy. Our simulation results in Section VI indicate that the impact of receiver collision on throughput and delay is negligible. This is consistent with [6] which has shown that the effect of receiver collisions is negligible if the number of nodes N is moderately large, which is typical for metro networks.
Non-persistence: If a control packet fails (in control packet contention or data packet scheduling) we draw a new independent random destination for the corresponding data packet. Our simulations in Section VI do not assume non-persistence and demonstrate that the non-persistence assumed in the probabilistic model gives accurate results.
   B. Control Packet Contention Analysis

A given control slot contains a successfully transmitted control packet if (i) it contains exactly one control packet corresponding to a newly arrived data packet (from one of the idle nodes) and no control packet from the backlogged nodes, or (ii) it contains exactly one control packet from a backlogged node and no control packet corresponding to newly arrived data packets. Let Xᵢ, i=1 . . . M, denote the number of control packets in slot i. The probability of a given slot containing a successfully transmitted control packet is:

$$P ( {X}_{i} = 1 ) = η \frac{σ}{M} {( 1 - \frac{σ}{M} )}^{η - 1} {( 1 - \frac{p}{M} )}^{N - η} + ( N - η ) \frac{p}{M} {( 1 - \frac{p}{M} )}^{N - η - 1} {( 1 - \frac{σ}{M} )}^{η} := κ , \qquad ( 1 )$$

where we assume for simplicity that the number of control packets corresponding to newly arrived data packets is independent of the number of control packets corresponding to backlogged data packets, which as our simulations indicate is reasonable.

The expected number of successfully transmitted control packets in each frame is

$${\sum }_{i = 1}^{M} P ( {X}_{i} = 1 ) ,$$

which has a binomial distribution BIN(M, κ). Hence the expected number of successful control packets per frame is M·κ.
C. A WG-PSC Mode Data Packet Scheduling

We assume that a data packet from each of the nodes is destined to any other node with equal probability. There are an equal number of nodes attached to each of the combiners and the splitters of a D×D AWG. Thus, the probability that a control slot contains a successfully transmitted control packet for data transmission between a given input-output port pair is κ/D². For notational convenience, let ρ:=κ/D².

In the AWG-PSC mode, the throughput of the network is the combined throughput of the AWG and the PSC. Nodes with successfully transmitted control packets are first scheduled using the wavelengths on the AWG. Let Z_{A} denote the expected throughput on the AWG (in packets per frame). With R FSRs serving each input-output port pair per half-frame, D input ports and D output ports, the expected number of packets transmitted per frame over the AWG is:

$${Z}_{A} = {D}^{2} \cdot {\sum }_{i = 1}^{2 \cdot R} i ( \begin{matrix}M \\ i\end{matrix} ) {{ρ}^{i} ( 1 - ρ )}^{M - i} + 2 \cdot R \cdot {D}^{2} \cdot {\sum }_{j = 2 R + 1}^{M} ( \begin{matrix}M \\ j\end{matrix} ) {{ρ}^{j} ( 1 - ρ )}^{M - j} . \qquad ( 2 )$$

If all of the FSRs for a given input-output pair are scheduled, then the next packet is scheduled on a PSC channel. Let Z_{P} denote the expected throughput over the PSC channels (in packets per frame). Let qᵢⱼ[n] denote the probability that there are n=0, 1, . . . , (M−2R), overflow packets from AWG input port i, i=1, . . . , D, to output port j, j=1, . . . , D. Recall that the control packets are uniformly distributed over the input-output port pairs. Thus, the overflows from all of the input-output port pairs have the same distribution. So we can drop the subscript ij. If the number of packets destined from an input port to an output port is R or less, then there is no overflow to the PSC. If the number of packets for the given input-output port pair is R+n with n≧1, then there are n overflow packets. Hence,

$$q [ n ] = \{ \begin{matrix}{\sum }_{i = 0}^{2 R} ( \begin{matrix}M \\ i\end{matrix} ) {{ρ}^{i} ( 1 - ρ )}^{M - i} & for n = 0. \\ ( \begin{matrix}M \\ n + 2 R\end{matrix} ) {{ρ}^{n + 2 R} ( 1 - ρ )}^{M - n - 2 R} & for n = 1 , … , M - 2 R .\end{matrix} \qquad ( 3 )$$

Let Q[m], m=1, . . . , (M−2R)·D², denote the probability that there are a total of m overflow packets. To simplify the evaluation of Q[m], we assume that the individual overflows are mutually independent. With this assumption, which as our verifying simulations (see Section VI) indicate gives accurate results, the distribution of the combined arrivals at the PSC Q[m] is obtained by convolving the individual qᵢⱼ[n]'s, i.e.,
Q[m]=q₁₁[n]*q₁₂[n]* . . . *q_{1D}[n]* . . . *q_{DD}[n]. (4)

With Q[m], we obtain the expected PSC throughput as approximately

$${Z}_{P} = {\sum }_{i = 1}^{Λ} i \cdot Q [ i ] + Λ \cdot {\sum }_{j = Λ + 1}^{( M - 2 R ) \cdot {D}^{2}} Q ( j ) . \qquad ( 5 )$$

The combined throughput from both AWG and PSC channels is the sum of Z_{A} and Z_{P}. To complete the throughput analysis, we note that in equilibrium the throughput is equal to the expected number of newly generated packets, i.e.,
Z_{A}+Z_{P}=σ·E[η]. (6)

For solving this equilibrium equation, we make the approximation that the number of idle nodes η has only small variations around its expected value E[η], i.e., η≈E[η], which as our verifying simulations in Section VI indicate gives accurate results. By now substituting equations (2) and (5) into (6), we obtain

$${D}^{2} \cdot {\sum }_{i = 1}^{2 R} i ( \begin{matrix}M \\ i\end{matrix} ) {( \frac{κ}{{D}^{2}} )}^{i} {( 1 - \frac{κ}{{D}^{2}} )}^{M - i} + 2 \cdot R \cdot {D}^{2} \cdot {\sum }_{j = 2 R + 1}^{M} ( \begin{matrix}M \\ j\end{matrix} ) {( \frac{κ}{{D}^{2}} )}^{j} {( 1 - \frac{κ}{{D}^{2}} )}^{M - j} + {\sum }_{i = 1}^{Λ} i \cdot Q [ i ] + Λ \cdot {\sum }_{j = Λ + 1}^{( M - 2 R ) \cdot {D}^{2}} Q [ j ] = σ \cdot η , \qquad ( 7 )$$

where κ is given by (1) and Q[·] is given by (4). We solve (7) numerically for η, which can be done efficiently using for instance the bisection method. With the obtained η we calculate κ (and p), and then Z_{A} and Z_{P}.
D. Delay

The average delay in the AWG∥PSC network is defined as the average time (in number of frames) from the generation of the control packet corresponding to a data packet until the transmission of the data packet commences. Since in the AWG-PSC mode the throughput of the network in terms of packets per frame is equal to Z_{A}+Z_{P}, the number of frames needed to transmit a packet is equal to 1/(Z_{A}+Z_{P}). Given that there are N−72 nodes in backlog and assuming that the propagation delay is smaller than the frame length, the average delay in number of frames is

$$Delay = \frac{N - η}{{Z}_{p} + {Z}_{A}} . \qquad ( 8 )$$

Propagation delays larger than one frame are considered in Appendix C.
E. PSC-Only Mode

In the PSC-only mode, the channels are shared by all of the nodes. We consider a scheduling window length of one frame. If a control packet is successfully transmitted, but the corresponding data packet cannot be transmitted due to lack of transmission resources, the node has to retransmit the control packet. The maximum number of packets transmitted per frame is equal to the number of channels Λ. The probability of a control slot containing a successfully transmitted control packet is given in (1). Hence, the expected number of successfully scheduled transmissions per frame Z_{PM} is

$${Z}_{PM} = {\sum }_{i = 1}^{Λ} i ( \begin{matrix}M \\ i\end{matrix} ) {{κ}^{i} ( 1 - κ )}^{M - i} + Λ \cdot {\sum }_{j = Λ + 1}^{M} ( \begin{matrix}M \\ j\end{matrix} ) {{κ}^{j} ( 1 - κ )}^{M - j} , \qquad ( 9 )$$

and in equilibrium the throughput is equal to the expected number of new packet arrivals, i.e.,
Z_{PM}=σ·E[η]. (10)
Z_{PM}, η, and κ are obtained by simultaneously solving equations (1), (9), and (10). Analogous to (8), the average delay is (N−E[η])/Z_{PM} frames.
F. AWG-Only Mode

In the AWG-only mode we consider two scenarios. In the first scenario, we set the length of the scheduling window to one frame. Recall that under this condition, there is no spatial wavelength reuse. In the second scenario we set the length of the scheduling window to D frames, i.e., one cycle. In this scenario there is full wavelength reuse.

Since transmissions in the AWG-only mode are organized into cycles, we define σ_{A} as the probability of an idle node having generated a new packet by the beginning of its transmission cycle. Given that an idle node generates a new packet with probability σ at the beginning of a frame, we have σ_{A}=1−(1−σ)^{D}. Similarly, we define p_{A} as the probability that a backlogged node re-transmits a control packet at the beginning of a cycle, where p_{A}=1−(1−p)^{D}. For a D×D AWG, N/D nodes are allowed to transmit control packets in a given frame. Thus the probability of a given control slot containing a successfully transmitted control packet is

$${κ}_{A} = \frac{η}{D} ( \frac{{σ}_{A}}{M} ) {( 1 - \frac{{σ}_{A}}{M} )}^{η / D - 1} {( 1 - \frac{{p}_{A}}{M} )}^{( N - η ) / D} + \frac{N - η}{D} ( \frac{{p}_{A}}{M} ) {( 1 - \frac{{p}_{A}}{M} )}^{( N - η ) / D - 1} {( 1 - \frac{{σ}_{A}}{M} )}^{η / D} . \qquad ( 11 )$$

The average throughput over the AWG in packets per frame is equal to the average number of packets transmitted from one given input port to the D output ports in one cycle. We assume that a control packet is destined to an output port with equal probability. The probability of a control slot containing a successfully transmitted control packet destined to a given output port is κ_{A}/D. The AWG accommodates up to R packets per input-output port pair per frame, since the R utilized FSRs provide R parallel wavelength channels between each input-output port pair. Without wavelength reuse, i.e., with a scheduling window of one frame, the nodes at a given input port can utilize the R wavelength channels that connect the considered input port to a given output port only during the latter half of one frame out of the D frames in a cycle. Hence, the expected number of successfully scheduled packets Z_{AM} per frame is

$${z}_{AM} = D \cdot {\sum }_{i = 1}^{R} i ( \begin{matrix}M \\ i\end{matrix} ) {( \frac{{κ}_{A}}{D} )}^{i} {( 1 - \frac{{κ}_{A}}{D} )}^{M - i} + R \cdot D \cdot {\sum }_{j = R + 1}^{M} ( \begin{matrix}M \\ j\end{matrix} ) {( \frac{{κ}_{A}}{D} )}^{j} {( 1 - \frac{{κ}_{A}}{D} )}^{M - j} . \qquad ( 12 )$$

We solve for η numerically using (11), (12) and the equilibrium condition Z_{AM}=σ_{A}·E[η]/D. With the obtained η we calculate κ_{A} and then Z_{AM}.

In the second scenario, i.e., with full wavelength reuse, successful control packets destined for a given output port not scheduled in the current frame are scheduled in the following frame, up to D frames. So the AWG accommodates up to R·D(=Λ) packets per input-output port pair per cycle. Hence, with wavelength reuse, the expected number of successfully scheduled packets Z_{RE} per frame is

$${Z}_{RE} = D \cdot {\sum }_{i = 1}^{R \cdot D} i ( \begin{matrix}M \\ i\end{matrix} ) {( \frac{{κ}_{A}}{D} )}^{i} {( 1 - \frac{{κ}_{A}}{D} )}^{M - i} + R \cdot {D}^{2} \cdot {\sum }_{j = R \cdot D + 1}^{M} ( \begin{matrix}M \\ j\end{matrix} ) {( \frac{{κ}_{A}}{D} )}^{j} {( 1 - \frac{{κ}_{A}}{D} )}^{M - j} . \qquad ( 13 )$$

Z_{RE}, η, and κ_{A} are obtained by simultaneously solving equations (11), (13) and the equilibrium condition Z_{RE}=σ_{A}·E[η]/D. With the obtained η we calculate κ_{A} and then Z_{RE}.

The maximum number of packets that the AWG can accommodate in the AWG-only mode with full wavelength reuse per frame can be increased from D·Λ to D·Λ+Λ by employing spreading techniques for the control packet transmissions. With spreading of the control packet transmissions, the nodes at a given AWG input port can send data packets in parallel with their control packets during the first half of the frame as studied in [4]. With an additional LED attached to the PSC, the nodes could send data packets in parallel with (spreaded) control packets over the PSC when the AWG∥PSC network runs in the AWG-PSC mode. This would increase the number of packets that the AWG∥PSC network can accommodate in the AWG-PSC mode per frame by Λ. In order not to obstruct the key ideas of the AWG∥PSC network, we do not consider the spreading of control information in this paper.

In the scenario without wavelength reuse, there are two delay components. The first component is the delay resulting from the control packet contention and the scheduling process. This component equals the number of backlogged nodes divided by the throughput. The second component is the waiting period in the transmission cycle. All of the idle nodes generate a new packet with probability a at the beginning a frame. But the nodes transmit control packets once every D frames. Hence, the expected waiting period from the generation of a new data packet to the transmission of the corresponding control packet is the mean of a truncated geometric distribution, i.e.,

$${I}_{del} = \frac{{\sum }_{i = 0}^{D} ( D - i ) \cdot σ \cdot {( 1 - σ )}^{i}}{1 - {( 1 - σ )}^{D}} . \qquad ( 14 )$$

Combining the two components, the total mean delay (in number of frames) is

$${Delay}_{AM} = \frac{N - E [ η ]}{{Z}_{AM}} + {I}_{del} . \qquad ( 15 )$$

In the scenario with wavelength reuse, there are three delay components. The first two components are the same as for the scenario without wavelength reuse. The third delay component occurs in the case when the number of scheduled packets is larger than D·R. In this case, the packets scheduled in the future frames experience an average delay of (Z_{RE}−D·R)⁺/(2·D·R) frames, where (Z_{RE}−D−R)⁺=max(0, Z_{RE}−D·R). To see this, note that if Z_{RE}>D·R, the packets not scheduled in the current frame have to wait an average (Z_{RE}−D·R)/(2·D·R) frames for transmission. Combining the three components, the total mean delay (in frames) is

$${Delay}_{RE} = \frac{N - E [ η ]}{{Z}_{RE}} + {I}_{del} + \frac{{( {Z}_{RE} - D \cdot R )}^{+}}{2 \cdot D \cdot R} . \qquad ( 16 )$$

### VI. Numerical and Simulation Results

In this section, we examine the throughput-delay performance of the AWG∥PSC network in the three operating modes: (i) AWG-PSC mode, (ii) PSC-only mode, and (iii) AWG-only mode, by varying system parameters around a set of default values, which are summarized in Table I

TABLE I
NETWORK PARAMETERS AND THEIR DEFAULT VALUES

| | | |
|---|---|---|
| N | number of nodes in network | 200 |
| D | degree (number of ports) of AWG | 4 |
| R | number of utilized FSRs | 2 |
| Λ | (=D · R). number of wavelengths | 8 |
| | (transceiver tuning range) | |
| p | packet re-transmission probability | 0.85 |
| | (=M/N) | |
| F | number of slots per frame | 340 |
| M | number of control slots per frame | 170 |
| σ | packet generation probability (traffic load) | |

(We set p=M/N as this setting gives typically a large probability κ of success in the control packet contention. Note from (1) that κ is maximized for p=(M−ησ)/(N−η−1).) We provide numerical results obtained from our probabilistic analysis (marked (A) in the plots) as well as from simulations of the network (marked with (S) in the plots). Each simulation was run for 10⁶ frames including a warm-up phase of 10⁵ frames; the 99% confidence intervals thus obtained were always less than 1% of the corresponding sample mean. Throughout the simulations, we used the σ values 0.01, 0.05, 0.10, 0.15, 0.2, 0.4, 0.6, 0.8, and 1.0. We note that in contrast to our probabilistic analysis, our simulations do take receiver collisions into consideration. Also, in the simulations a given node does not transmit to itself. In addition, in the simulations, we do not assume non-persistence, i.e., the destination of a data packet is not renewed when the corresponding control packet is unsuccessful.

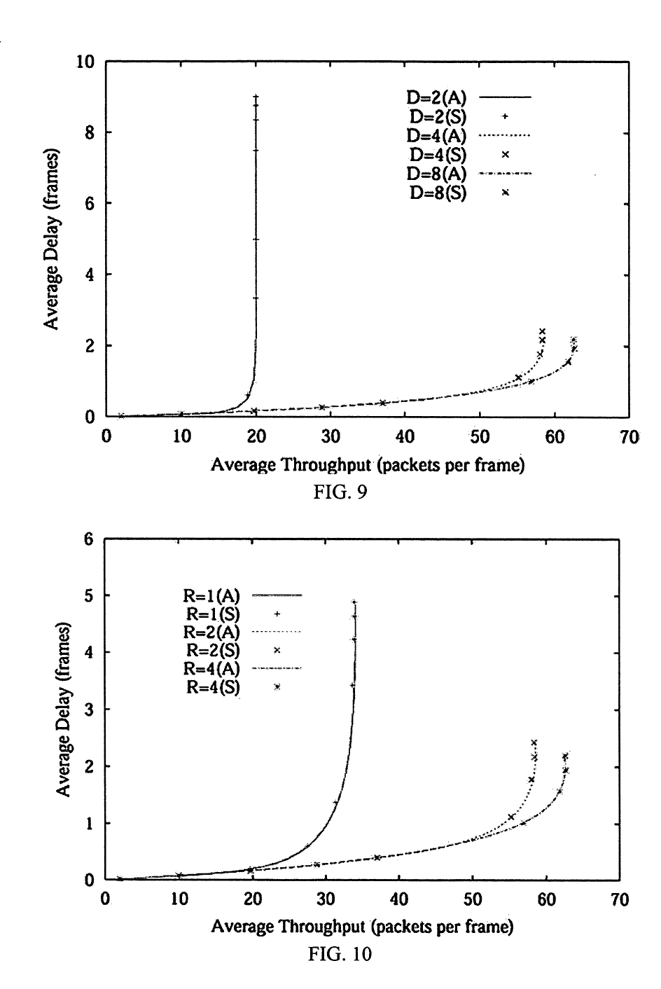

FIG. 9 compares the throughput-delay performance of the network for different AWG degrees D=2, 4, and 8 (with the number of used FSRs fixed at R=2, thus the corresponding Λ values are 4, 8, and 16). For small σ, the throughput-delay performance for the three D values are about the same. For large σ, the throughput for D=2 peaks at 20 packets per frame and the delay shoots up to very large values. A network constructed using D=8 achieves higher throughput at lower delays compared to the D=4 network at high traffic levels. Recall that the wavelength reuse property of the AWG allows each wavelength to be simultaneously used at all of the input ports, thus providing D·Λ channels. Furthermore, each AWG FSR at each port accommodates 2 data packet transmissions per frame. Thus the maximum combined throughput of AWG and PSC is 2 D·Λ+Λ data packets per frame. For D=2, the maximum throughput is 20 packets per frame as indicated in the graph. The maximum throughput for D=4 and D=8 are 72 and 272 packets per frame, respectively. For these two cases, the throughput is primarily limited by the number of successful control packets (per frame); whereas the data packet scheduling is the primary bottleneck for D=2.

FIG. 10 compares the throughput-delay performance of the network for different numbers of used FSRs R=1, 2, and 4 (with the AWG degree fixed at D=4, thus the corresponding Λ values are 4, 8, and 16). The throughput for R=1 peaks at 32 packets per frame and the delay grows to large values, while the throughput and delay for R=2 and R=4 are approximately the same. Increasing R increases the number of channels for each input-output port pair on the AWG, thus increasing the number of channels in the network. For R=1, the maximum throughput is 2·D·Λ+Λ=36 packets per frame. The throughput is primarily limited by the scheduling capacity of the network. For R=2 and R=4 the 21 maximum throughputs are 72 and 144 packets per frame, respectively. For these two cases, the throughput is primarily limited by the number of control packets that are successful in the control packet contention. The conclusion is that increasing the number of channels for each input-output port pair does not yield measurable improvements in throughput or delay when there are not enough successful control packets.

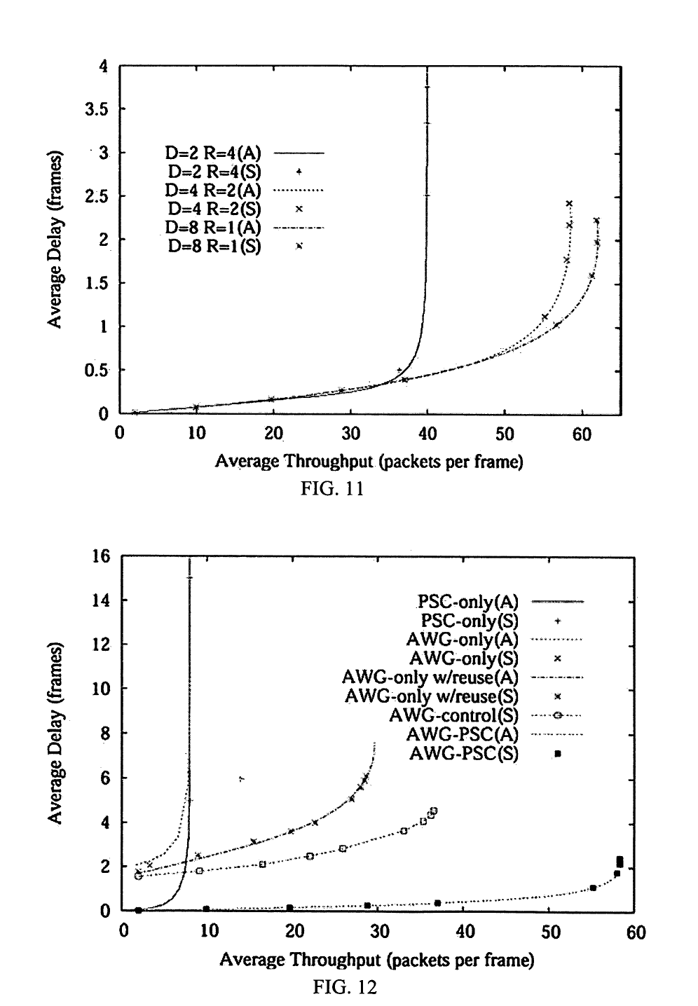

In FIG. 11, we fix the number of wavelengths in the network (Λ=8) and examine the throughput-delay performance for different combinations of D and R with D·R=8. We examine the cases: (D=2, R=4), (D=4, R=2), and (D=8, R=1). We observe that (D=2, R=4) has the shortest delay up to a throughput of about 34 packets per frame, and a maximum throughput of 40 packets per frame. The delays for (D=4, R=2) and (D=8, R=1) are approximately the same up to a throughput of approximately 48 data packets per frame. At higher traffic levels, the (D=8, R=1) network achieves higher throughput at lower delays compared to the (D=4, R=2) network due to the larger number of channels in the (D=8, R=1) network. The combination (D=2, R=4) achieves the shortest delay at small σ due to higher channel utilization from the larger number of FSRs. The throughput for (D=2, R=4) is bounded by the scheduling capacity of 2·D·Λ+Λ=40 data packets per frame.

FIG. 12 compares the throughput-delay performance of the network in the four modes: PSC-only mode, AWG-only mode without wavelength reuse (i.e., a scheduling window of one frame), AWG-only mode with wavelength reuse (i.e., a scheduling window of one cycle), and AWG-PSC mode. The PSC-only mode has a maximum throughput of 8 data packets per frame. This is expected because the maximum number of channels in a PSC-network is equal to the number of available wavelengths, A=8. The AWG-only mode with wavelength reuse achieves throughputs up to roughly 30 packets per frame. This is primarily due to the larger number of D·A=32 available wavelength channels with spatial wavelength reuse. The delay for the AWG-only mode is larger than for both the PSC-only mode and the AWG-PSC mode at low traffic. This is due to the cyclic control packet transmission in the AWG-only mode. The AWG-PSC mode achieves the largest throughput and the smallest delays for all levels of traffic.

We also observe that for a given level of delay, the throughput for the AWG∥PSC network is significantly larger than the total throughput obtained by combining the throughput of a stand-alone AWG network with the throughput of a stand-alone PSC network. The AWG∥PSC network in the AWG-PSC mode has a maximum throughput of 59 packets per frame and a delay of no more than 3 frames. For the same level of delay, the throughput of a stand-alone PSC network and a stand-alone AWG network are 8 and 12 packets per frame, respectively. So by combining the AWG and the PSC in the AWG∥PSC network, we effectively tripled the total combined throughput of two stand-alone networks.

A. Comparison of AWG∥PSC Network with AWG∥AWG Network and PSC∥PSC Network

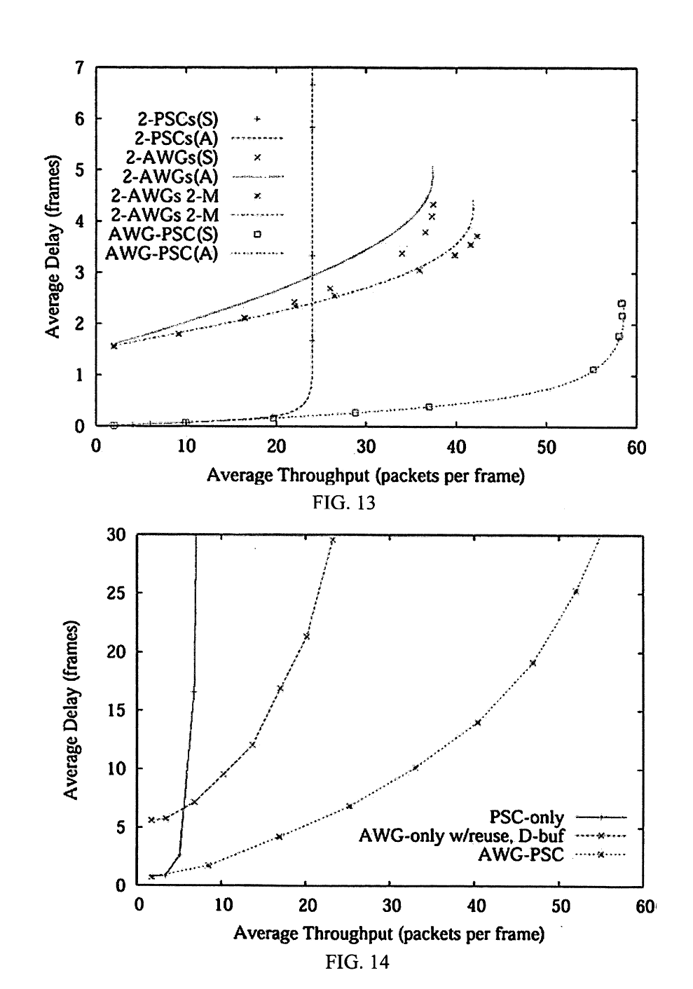

Next, we compare the AWG∥PSC network to its peers of homogeneous two-device networks. FIG. 13 compares the throughput-delay performance of the AWG∥PSC network with a PSC∥PSC network (consisting of two PSCs in parallel) and an AWG∥AWG network (consisting of two AWGs in parallel). The throughput-delay performance of these homogeneous two device networks is analyzed in detail in Appendix A. In brief, in the PSC∥PSC network an idle node generates a new packet with probability a at the beginning of a frame. In the AWG∥AWG network an idle node generates a new packet with probability σ_{A}=1−(1−σ)^{D} at the beginning of a cycle and data packets are scheduled with full wavelength reuse, i.e., a scheduling window of one cycle.

We observe that the average throughput of the AWG∥PSC network is significantly larger and the delay significantly smaller than for the other two two-device networks. In the PSC∥PSC network, we observe a maximum average throughput of 24 packets per frame. We imposed the control packet contention only on one of the devices. This allows for the scheduling of up to two data packets per frame on the second PSC, which effectively allows for the scheduling of up to three data packets per wavelength on the PSC∥PSC network in each frame. With A=8 wavelengths available, the PSC∥PSC network has a maximum throughput of 24 data packets per frame. An alternative framing structure is to have control packet contention on both PSCs. This would double the number of contention slots per frame, but would reduce the scheduling capacity to 16 data packets per frame. Since the number of wavelength channels is the obvious bottleneck for the PSC∥PSC network, we chose the former framing method to alleviate the bottleneck for data transmission.

For the AWG∥AWG network, we present numerical and simulation results for two framing structures. The first framing structure has control contention only on one of the AWGs. The second framing structure (marked 2-M in the plots) has control packet contention slots and data slots imposed on both devices. We observe that the framing structure with control contention on both AWGs achieves larger throughput and smaller delays compared to the framing structure with contention over one AWG. The maximum average throughput for one control slot contention and two control contentions are 37 packets and 42 packets per frame, respectively. Using one control contention per frame, the maximum throughput is 3·D·Λ=96 data packets per frame. Using two control contentions per frame, the maximum throughput is 2 D·Λ=64 data packets per frame. Although the two-control contention framing structure has fewer data slots, it has a larger probability of success for control packet contention, thus resulting in larger throughput and smaller delay. The primary reason that the throughput levels in both of these framing structures are significantly smaller than their data scheduling capacity is the lower traffic as a result of the cyclic control packet transmission structure. For σ=1 an idle node in the PSC∥PSC or AWG∥PSC network generates a new packet with probability one at the beginning of a frame, whereas an idle node in the AWG∥AWG network generates a new packet with the corresponding probability σ_{A}=1 at the beginning of a cycle (consisting of D frames). In other words, the AWG∥AWG network is “fed” with a smaller input traffic rate since each node generates at most one new packet in a cycle. Thus the maximum number of control packets corresponding to new data packet in a 200-node network with a 4×4 AWG is 50 control packets per frame.

To get a better understanding of the relative performance of the AWG∥PSC network with respect to the AWG∥AWG network, we consider an alternative operation of the AWG∥AWG network, which ensures that both networks are “fed” with the same traffic rate. Specifically, we equip each node in the AWG∥AWG network with D packet buffers; one for each of the frames in a cycle. (Each node in the AWG∥PSC continues to have only one packet buffer.) Each node in the AWG∥AWG network generates a new packet with probability a at the beginning of a frame if the buffer corresponding to that frame is idle. As explained in Section IV-C the nodes in the AWG∥AWG network can only send control packets in the one frame (out of the D frames in the cycle) that is assigned to the node's combiner. Whereas in the single-buffer operation considered in Section IV-C and Section V-F above, a node sends at most one control packet in that assigned frame, in the D-buffer operation considered here a node sends up to D control packets—one for each of the packets in its D buffers—in the assigned frame. The control packet contention and data packet scheduling for this D-buffer operation of the AWG∥AWG network and the resulting throughput-delay performance are analyzed in detail in Appendix B.

FIG. 14 compares the throughput-delay performance for the AWG∥PSC network with the throughput-delay performance of the AWG∥AWG network with D-buffer operation, both with control packet contention on one AWG and on two AWGs. We observe that the AWG∥AWG network with D-buffer operation achieves somewhat larger throughput than the AWG∥PSC network. However, the AWG∥PSC network achieves significantly smaller delay throughout. While the comparison in FIG. 14 is fair in that both networks are “fed” with the same traffic rate, the AWG∥AWG network is given the advantage of D packet buffers and a scheduling window of D frames (both resulting in higher complexity), whereas the AWG∥PSC network has a single packet buffer and a scheduling window of one frame. The comparisons in both FIG. 13 and FIG. 14 indicate that the AWG∥PSC network achieves good throughput-delay performance at low complexity.

B. AWG PSC Network Performance for Self-Similar Traffic

In this section, we examine the throughput-delay performance of the AWG∥PSC network in its three operating modes for a more general traffic model. In particular, we consider self-similar packet traffic with a Hurst parameter of 0.75, which we generate from ON/OFF processes with Pareto distributed on-duration and geometrically distributed off-duration See K. Park and W. Willinger [42]. We equip each node with a large buffer such that essentially no packet is dropped and run simulations to obtain the packet throughput and delay.

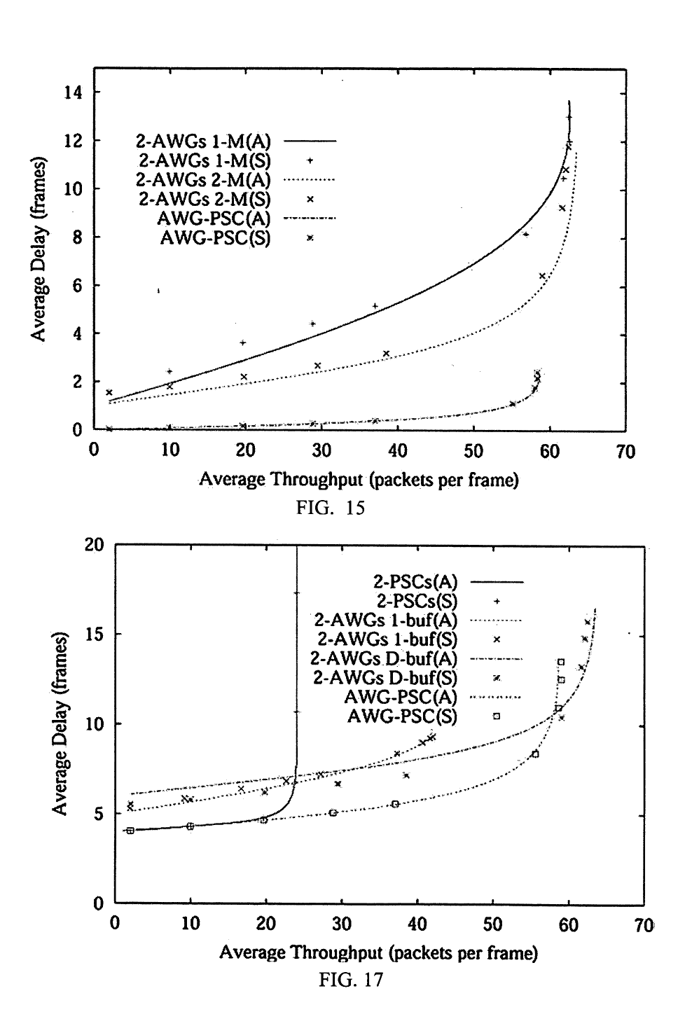

In FIG. 15, we compare the throughput-delay performance for the PSC-only mode, the AWG-only mode with wavelength reuse, and the AWG-PSC mode. For the AWG-only mode with wavelength reuse we consider the -buffer operation in which a node can send up to control packets in its assigned frame, as introduced in the preceding section. The single-buffer operation of the AWG in which a node can send at most one control packet in its assigned frame (out of the frames in a cycle) would give significantly larger delays for the persistent packet bursts of the self-similar traffic. We observe from FIG. 15 that similar to the results for Bernoulli traffic in FIG. 12, the AWG-PSC mode achieves significantly larger throughput for a given level of delay than the combined throughput of the PSC-only mode and AWG-only mode. For a wide range of delay levels the AWG PSC network achieves close to twice the throughput of a stand-alone PSC network and a stand-alone AWG network. We also observe by comparing FIG. 15 with FIG. 12 that for a given level of throughput, the delay for each of the operating modes for the self-similar traffic scenario is larger than the delay for the Bernoulli traffic scenario. This is due to the arrival of persistent packet bursts and the node buffering in the self-similar traffic scenario.

### VII. CONCLUSION

From the foregoing it will be apparent to those of skill in the art that the AWG∥PSC network according to the present invention addresses the problem of the single point of failure in single-hop WDM. The AWG∥PSC network achieves high survivability through heterogeneous protection (i.e., the AWG and the PSC protect each other); the network remains functional when either the AWG or the PSC fails. The AWG∥PSC network provides enhanced throughput-delay performance by exploiting the respective strengths of the AWG (periodic wavelength routing, spatial wavelength reuse) and the PSC (efficient broadcast) during normal operation. We note that the heterogeneous protection described herein is a general approach, i.e., it can be applied to the PSC based networks reported in the literature in analogous fashion. We also note that the network provides a flexible infrastructure for efficient optical multicasting. A multicast destined to the receivers at one AWG output port could be conducted over the AWG, while a multicast destined to receivers at several AWG output ports may be conducted more efficiently over the PSC.

Additional advantages and modifications will readily occur to those skilled in the art. Therefore, the invention in its broader aspects is not limited to the specific details, representative devices, and illustrative examples shown and described. Accordingly, departures may be made from such details without departing from the spirit or scope of the general inventive concept as defined by the appended claims and their equivalents.

### REFERENCES

The following references are incorporated herein in their entirety by this reference:
[1] B. Mukherjee, “WDM-based local lightwave networks part I: Single-hop systems,” IEEE Network, vol. 6, no. 3, pp. 12-27, May 1992.
[2] N. E Caponio, A. M. Hill, F. Neri, and R. Sabella, “Single-layer optical platform based on WDM/TDM multiple access for large-scale ‘switchless’ networks,” European Trans. on Telecomm., vol. 11, no. 1, pp. 73-82, January/February 2000.
[3] K. Kato, A. Okada, Y Sakai, and K. N. et al., “10-Tbps full-mesh WDM network based on a cyclic-frequency arrayed-waveguide grating router,” in Proc. of ECOC '00, vol. 1, Munich, Germany, September 2000, pp. 105-107.
[4] M. Maier, M. Reisslein, and A. Wolisz, “A hybrid MAC protocol for a metro WDM network using multiple free spectral ranges of an arrayed-waveguide grating,” Computer Networks, in press, 2002, a shorter version appeared under the title “High Performance Switchless WDM Network Using Multiple Free Spectral Ranges of an Arrayed-Waveguide Grating”, in Proceedings of SPIE Terabit Optical Networking: Architecture, Control, and Management Issues, pages 101-112, Boston, Mass., November 2000. The paper won the Best Paper Award of the conference.
[5] F. Ruehl and T. Anderson, “Cost-effective metro WDM network architectures,” in OFC 2001 Technical Digest, paper WLI, Anaheim, Calif., March 2001.
[6] M. Maier, M. Scheutzow, M. Reisslein, and A. Wolisz, “Wavelength reuse for efficient transport of variable-size packets in a metro WDM network,” in Proc. of IEEE Infocom '02, New York, N.Y., June 2002, pp. 1432-1441.
[7] A. Hill, M. Brierley, R. Percival, R. Wyatt, D. Pitcher, K. Pati, I. Hall, and J.-P. Laude, “Multi-star wavelength-router network and its protection strategy,” IEEE J. Select. Areas Commun., vol. 16, no. 7, pp. 1134-1145, September 1998.
[8] Y Sakai, K. Noguchi, Y Yoshimura, T. Skamoto, and et al., “Management system for full-mesh WDM AWG-star network,” in Proc. 27^{th} Eur. Conf. on Opt. Comm., vol 3, Amsterdam, Netherlands, Sep./October 2001, pp. 264-265.
[9] M. Maier, M. Reisslein, and A. Wolisz, “Towards efficient packet switching metro WDM networks,” Optical Networks Magazine, vol. 3, no. 6, pp. 44-62, November/December 2002.
[10] M.-S. Chen, N. Dono, and R. Ramaswami, “A media-access protocol for packet-switched wavelength division multiaccess metroplitan area networks,” IEEE Journal on Selected Areas in Communication, vol. 8, no. 6, pp. 1048-1057, August 1990.
[11] R. Chipalkatti, Z. Zhang, and A. S. Acampora, “Protocols for optical star-coupler network using WDM: Performance and complexity study,” IEEE Journal on Selected Areas in Communications, vol. 11, no. 4, pp. 579-589, May 1993.
[12] P. W. Dowd, “Random access protocols for high-speed interprocessor communication based on an optical passive star-topology,” IEEE/OSA J. of Lightwave Technol., vol. 9, no. 6, pp. 799-808, June 1991.
[13] A. Ganz and Y Gao, “Time-wavelength assignment algorithms for high performance WDM star based systems,” IEEE Trans. on Commun., vol. 42, no. 2/3/4, pp. 1827-1836, February/March/April 1994.
[14] I. M. I. Habbab, M. Kavehrad, and C.-E. W. Sundberg, “Protocols for very high-speed optical fiber local area networks using a passive star topology,” IEEE/OSA J of Lightwave Technol., vol. LT-5, no. 12, pp. 1782-1794, April 1987.
[15] M. J. Karol and B. Glance, “A collision-avoidance WDM optical star network,” Computer Networks and ISDN Systems, vol. 26, pp. 931-943, March 1994.
[16] K. Li, “Probabilistic analysis of cyclic packet transmission scheduling in WDM optical networks,” in Proceedings of IEEE International Conference on Parallel Processing, March 2000, pp. 531-538.
[17] H. C. Lin and C. H. Wan, “A hybrid multicast scheduling algorithm for single-hop WDM networks,” IEEE/OSA Journal of Lightwave Technology, vol. 19, no. 11, pp. 1654-1664, November 2001.
[18] J. Lu and L. Kleinrock, “A wavelength division multiple access protocol for high-speed local area networks with a passive star topology,” Performance Evaluation, vol. 16, no. 1-3, pp. 223-239, November 1992.
[19] N. Mehravari, “Performance and protocol improvements for very high speed optical fiber local area networks using a passive star topology,” IEEE/OSA J of Lightwave Technol., vol. 8, no. 4, pp. 520-530, April 1990.
[20] Y Ofek and M. Sidi, “Design and analysis of hybrid access control to an optical star using WDM,” in Proc. of IEEE Infocom '91, Bal Harbour, Fla., May 1991, pp. 20-31.
[21] G. N. M. Sudhakar, N. D. Georganas, and M. Kavehrad, “Slotted Aloha and Reservation Aloha protocols for very high-speed optical fiber local area networks using passive star topology,” IEEE/OSA J of Lightwave Technol., vol. 9, no. 10, pp. 1411-1422, October 1991.
[22] B. Kannan, S. Fotedar, and M. Gerla, “A two level optical star WDM metropolitan area network,” in Proc. of IEEE Globecom '94 Communications, San Francisco, Calif., November 1994.
[23] M. Janoska and T. Todd, “Coupled reservation protocols for hierarchical single-hop photonic networks,” IEEE Proceedings Communications, vol. 144, no. 4, pp. 247-255, August 1997.
[24] C. J. Chae, H. Park, and Y Park, “Hybrid optical star coupler suitable for wavelength reuse,” IEEE Photonic Technology Letters, vol. 10, no. 2, pp. 279-281, February 1998.
[25] D. Banerjee, J. Frank, and B. Mukherjee, “Passive optical network architecture based on waveguide grating routers,” IEEE Journal on Selected Areas in Communications, vol. 16, no. 7, pp. 1040-1050, September 1998.
[26] B. Glance and M. Karol, “Large capacity multiaccess optical packet network,” IEEE Photonic Technology Letters, vol. 6, no. 7, pp. 872-875, July 1994.
[27] K. Bengi, “Performance of single-hop WDM LANs supporting real-time services,” Photonic Network Communications, vol. 1, no. 4, pp. 287-301, December 1999.
[28] E. Arthurs, J. Cooper, M. Goodman, H. Kobrinski, M. Tur, and M. Vecchi, “Multiwavelength optical crossconnect for parallel-processing computers,” IEE Electronics Letters, vol. 24, no. 2, pp. 119-120, January 1988.
[29] B. Glance, I. E Kaminow, and R. W Wilson, “Applications of the integrated waveguide grating router,” IEEE/OSA J Lightwave Technol., vol. 12, no. 6, pp. 957-962, June 1994.
[30] A. Saleh and H. Kogelnik, “Reflective single-mode fiber-optic passive star couplers,” IEEE/OSA Journal of Lightwave Technology, vol. 6, no. 3, pp. 392-398, March 1988.
[31] M. Tabiani and M. Kavehrad, “Theory of an efficient N×N passive optical star-coupler,” IEEE/OSA Journal of Lightwave Technology, vol. 9, no. 4, pp. 448445, April 1991.
[32] C. Dragone, “Optimum design of a planar array of tapered waveguides,” J. Opt. Soc. Amer., vol. 7, pp. 2081-2093, November 1990.
[33] C. Dragone, C. Edwards, and R. Kistler, “Integrated optics N×N multiplexer on silicon,” IEEE Photon. Techno. Lett., vol. 3, no. 10, pp. 896-899, October 1991.
[34] Y Hibino, “An array of photonic filtering advantages,” Circuits and Devices, pp. 23-27, November 2000.
[35] K. McGreer, “Arrayed waveguide gratings for wavelength routing,” IEEE Communications Magazine, vol. 36, no. 12, pp. 62-68, December 1998.
[36] Y. Tachikawa, Y Inoue, M. Ishii, and T. Nozawa, “Arrayed waveguide grating multiplexer with loop-back optical paths and its applications,” Journal of Lightwave Technology, vol. 14, no. 6, pp. 977-984, June 1996.
[37] P. Bernasconi, C. Doerr, C. Dragone, and M. C. et al., “Large n×n waveguide grating routers,” IEEE/OSA Journal of Lightwave Technology, vol. 18, no. 7, pp. 985-991, July 2000.
[38] K. M. Sivalingam, “Design and analysis of a media access protocol for star coupled WDM networks with TT-TR architecture,” in Optical WDM Networks—Principles and Practice, Chapter 9, K. M. Sivalingam and S. Subramaniam, Eds. Kluwer Academic Publishers, 2000.
[39] M. Cerisola, T. Fong, R. Hofmeister, and et al., “Novel distributed slot synchronization technique for optical WDM packet networks,” in OFC 1996 Technical Digest, paper FD1, 1996, pp. 314-315.
[40] R. Hofmeister, C. Lu, M. Ho, and et al., “Distributed slot synchronization (DSS): a network-wide slot synchronization technique for packet-switched optical networks,” IEEE/OSA Journal of Lightwave Technology, vol. 16, no. 12, pp. 2109-2116, December 1998.
[41] C.-S. Li and R. Ramaswami, “Automatic fault detection, isolation, and recovery in transparent all-optical networks,” IEEE J Lightwave Technol., vol. 15, pp. 1784-1793, October 1997.
[42] K. Park and W. Willinger, Eds., Self-Similar Network Traffic and Performance Evaluation, New York: Wiley, 2000.

### Appendix A

### Throughput-Delay Analysis for PSC∥PSC Network and AWG∥AWG Network

In this appendix we analyze the throughput-delay performance of the PSC∥PSC network and the AWG∥AWG network. We make the following traffic assumptions for these two homogeneous networks:
A node selects one of the two devices with equal probability for transmission.
Each node can have at most one data packet in the buffer to ensure a fair comparison with the AWG∥PSC network.
   A. PSC∥PSC Network

For the PSC∥PSC network with control packet contention over one PSC, the control packet contention analysis is the same as in Section V-B. Because we can schedule up to three data packets per frame on each wavelength; one data packet per frame on the PSC with contention phase, two data packets per frame on the PSC dedicated to data, the throughput for the PSC∥PSC network is:

$${Z}_{2 PM} = {\sum }_{i = 1}^{3 \cdot Λ} i ( \begin{matrix}M \\ i\end{matrix} ) {{κ}^{i} ( 1 - κ )}^{M - i} + 3 \cdot Λ \cdot {\sum }_{j - 3 Λ + 1}^{M} ( \begin{matrix}M \\ j\end{matrix} ) {{κ}^{j} ( 1 - κ )}^{M - j} . \qquad ( 17 )$$

The equilibrium condition for the PSC∥PSC network is Z_{2PM}=σ·E[η], which is used to solve numerically for η. The average delay (in frames) is (N−E[η])/Z_{2PM}.
B. AWG∥AWG Network

For the AWG∥AWG network, we consider two scenarios: (i) control contention over one AWG, and (ii) control contention over both AWGS. In the case of control contention over one AWG, the contention analysis is the same as in Section V-F. The throughput is modified to reflect the additional two data packets that can be scheduled per FSR per frame on the AWG dedicated to data transmission:

$${Z}_{1 M} = D \cdot {\sum }_{i = 1}^{3 Λ} i ( \begin{matrix}M \\ i\end{matrix} ) {( \frac{{κ}_{A}}{D} )}^{i} {( 1 - \frac{{κ}_{A}}{D} )}^{M - i} + 3 \cdot R \cdot {D}^{2} \cdot {\sum }_{j = 3 Λ + 1}^{M} ( \begin{matrix}M \\ j\end{matrix} ) {( \frac{{κ}_{A}}{D} )}^{i} {( 1 - \frac{{κ}_{A}}{D} )}^{M - j} . \qquad ( 17 )$$

The equilibrium condition is Z_{1M}=σ_{A}·E[η]/D, which is again used to solve numerically for η.

In the scenario of control contention over both AWGs, we assume that a node selects one of the two devices with equal probability for transmission. We define σ_{2A} as the probability that a given idle node generates a new packet by the beginning of its transmission cycle and sends this control packet to a given AWG. Clearly, σ_{2A}=1−(1−σ/2)^{D}. Similarly, we define p_{2A} as the probability that a given backlogged node re-transmits a control packet over a given AWG at the beginning of a given cycle. Clearly, p_{2A}=1−(1−p/2)^{D}. The probability that a given control slot on a given AWG contains a successfully transmitted control packet is

$${k}_{2 A} = \frac{{ησ}_{2 A}}{DM} {( 1 - \frac{{σ}_{2 A}}{M} )}^{η / D - 1} {( 1 - \frac{{P}_{2 A}}{M} )}^{( N - η ) / D} + \frac{( N - η ) {p}_{2 A}}{DM} {( 1 - \frac{{p}_{2 A}}{M} )}^{( N - η ) / D - 1} {( 1 - \frac{{σ}_{2 A}}{M} )}^{η / D} . \qquad ( 19 )$$

This κ_{2A} is used to evaluate the average throughput over a given AWG, which—for a scheduling window of one cycle—is given by:

$${Z}_{2 M} = D \cdot {\sum }_{i = 1}^{Λ} i ( \begin{matrix}M \\ i\end{matrix} ) {( \frac{{κ}_{2 A}}{D} )}^{i} {( 1 - \frac{{κ}_{2 A}}{D} )}^{M - i} + R \cdot {D}^{2} \cdot {\sum }_{j - Λ + 1}^{M} ( \begin{matrix}M \\ j\end{matrix} ) {( \frac{{κ}_{2 A}}{D} )}^{j} {( 1 - \frac{{κ}_{2 A}}{D} )}^{M - j} . \qquad ( 20 )$$

The equilibrium condition is Z_{2M}=σ_{2A}·E[η]/D, which is again used to solve numerically for η. The average throughput of the AWG∥AWG network (in packets per frame) is then given as 2·Z_{2M} and the average delay in the network (in frames) is (N−E[η])/(2·Z_{2M})+I_{del}+(Z_{2M}−D·R)⁺/(2·D·R).

### Appendix B

### Throughput-Delay Analysis for the AWG∥AWG Network with D-Buffer Operation

In this appendix we analyze the throughput-delay performance of the AWG∥AWG network with D-buffer operation and full wavelength reuse (i.e., a scheduling window of one cycle). In the D-buffer operation, an idle buffer corresponding to a given frame (out of the D frames in the cycle) generates a new packet with probability a at the beginning of that frame. In the frame assigned to the node for control packet transmission, control packets are sent for all packets that have been newly generated in the past D frames. In addition, control packets are sent for each backlogged (packet) buffer with probability p. Let η_{D} denote the total number of idle buffers in the network. Note that there are D·N−η_{D} backlogged buffers in the network. Also note that each frame is assigned N/D nodes for control packet transmission. Thus, in equilibrium, there are η_{D}/D=η newly generated packets contenting in a given frame. In addition, there are (D·N−η_{D})/D=N−η backlogged buffers contending in a given frame. Thus the probability of a control slot containing a successfully (without collision) transmitted control packet is κ given in (1). The throughput of the AWG∥AWG network in D-buffer operation with control packet contention on one AWG is thus obtained by replacing κ_{A} by κ in (18) and σ_{A} by σ the corresponding equilibrium condition.

The throughput of the AWG∥AWG network in D-buffer operation with control packet contention on two AWGs is obtained by replacing κ_{2A} by

$$η ( \frac{σ}{2 M} ) {( 1 - \frac{σ}{2 M} )}^{η - 1} {( 1 - \frac{p}{2 M} )}^{N - η} + ( N - η ) ( \frac{p}{2 M} ) {( 1 - \frac{p}{2 M} )}^{N - η - 1} {( 1 - \frac{σ}{2 M} )}^{η} \qquad ( 21 )$$

in the corresponding equilibrium condition.

### Appendix C

### Analysis of Impact of Propagation Delay

Recall that the analysis in Section V assumed that the one-way end-to-end propagation delay in the network is less than one frame. In this appendix, we develop a more general analytical model, which accommodates larger propagation delays. This more general model allows us to accurately characterize the performance of the AWG∥PSC network for the larger propagation delays in realistic networking scenarios.

For our analysis, we assume that all nodes are equidistant from the central AWG∥PSC. (This can be achieved in a straightforward manner by employing standard low-loss fiber delay lines.) Let τ denote the one-way end-to-end (from a given node to the central AWG PSC and on to an arbitrary node) propagation delay in integer multiples of frames (as defined in Section IV). We furthermore assume that each node has a buffer that holds τ+1 packets.

In a typical scenario with a distance of 50 km from each node to the central AWG∥PSC and a propagation speed of 2·10⁸ m/sec, the one-way end-to-end propagation delay is 0.5 msec. With an OC48 transmission rate of 2.4 Gbps and a frame size of 1,596 bytes (corresponding to a maximum size Ethernet frame) the propagation delay is τ=94 frames. (Buffering the corresponding 94 packets requires at most 150 kbytes of buffer in the electronic domain.) Note that if we had considered a frame size corresponding to the maximum size of a SONET frame of 1,600 kbytes, the propagation delay would only be a fraction of one frame, which is accommodated by the analysis in Section V.

We now proceed with the analysis for a propagation delay of multiple frames. The basic time unit in our analysis is the slot, i.e., the transmission time of a control packet, as defined in Section IV. Note that a propagation delay of τ frames is equivalent to a delay of τ·F slots. For our analysis, we introduce the concept of time-sequenced buffering.

A. Time-Sequenced Buffering at Nodes

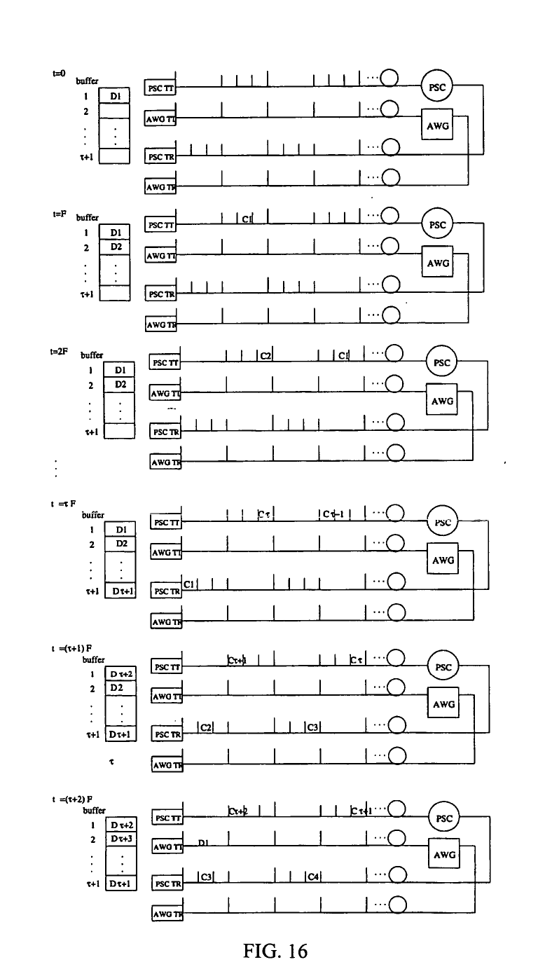

We view a given node's buffer capable of holding τ+1 packets as consisting of τ+1 buffer slots, as illustrated in FIG. 16. Each buffer slot can hold one packet. In each frame, one of the buffer slots is the active buffer slot. The active buffer slot behaves exactly in the same way as the single-packet buffer considered in Section V, i.e., if idle, it generates a new packet with probability ar and sends a control packet. If backlogged it sends a control packet with probability p.

The other τ buffer slots are inactive. The inactive buffer slots do not generate any new packets nor do they send any packets into the network. The purpose of the inactive buffer slots is to hold the data packets that correspond to the control packets that are propagating in the network.

A given buffer slot that is active in a given frame is inactive in the following τ frames (allowing each of the τ other buffer slots to be active for one frame), and then becomes again active τ+1 frames later.

Suppose a buffer slot is active in a given frame and in one of the M control slots in this frame sends out a control packet. This control packet arrives back at the node by the time the buffer slot becomes again active at the start of the (τ+1)th frame (i.e., after “sitting out” for τ frames). If the control packet is successful in control packet contention and data packet scheduling, the corresponding data packet is sent out in this (τ+1)th frame.

Also if the control packet is successful, a new data packet is generated with probability a at the beginning of this (τ+1)th frame. If a new data packet is generated, the corresponding control packet is sent in one of the M control slots of the (τ+1)th frame. Note that we have tacitly assumed here that the nodal processing takes no more than F−M slots. If the processing delay is larger, it can be accommodated in a straightforward manner by adding more buffer slots.

For an illustration of the concept of time-sequenced buffering, consider the buffer slots of a given node depicted in FIG. 16. Suppose buffer slot 1 is empty prior to time τ=0, and generates a new packet, designated by D(1), at t=0. The control packet corresponding to D(1), designated by C(1), is sent in one of the M control slots of the frame that is sent between t=0 and t=F (slots). By the time t=F, this frame is completely “on the fiber”, as illustrated in the second snapshot in FIG. 16. (Note that this frame contains no data packets, as we assumed that buffer slot 1 was empty before t=0.) At t=F, buffer slot 1 becomes inactive, while buffer slot 2 becomes active. Suppose the node generates a new data packet D(2) at t=F. At t=2F the frame with the control packet C(2) is completely on the fiber and buffer slot 3 becomes active, and so on.

At time t=τF the frame containing C(1) starts to arrive back at the node. By time t=τF+M, the control packet is completely received and its processing commences. With an assumed processing delay of less than F−M slots, the processing is completed by τ=(τ+1)F, which is exactly when buffer slot 1 becomes again active. Suppose C(1) was successful and the corresponding D(1) is scheduled on the AWG. Also suppose a new data packet D(τ+2) is generated at t=(τ+1)F. By t=(τ+2)F, the frame containing D(1) and C(τ+2) is completely on the fiber, and buffer slot 2 becomes active, and so on.

B. Network Analysis

The key insight to the analysis of the network with time-sequenced buffering at the nodes is that in steady state it suffices to consider only the active buffer slot at each of the N network nodes. Specifically, at each instance in time, each node has exactly one active buffer slot. This active buffer slot is either idle or backlogged (similar to the way a node is either idle or backlogged in the analysis of Section V). A buffer slot is considered idle if (i) it contains no data packet, or (ii) it successfully transmitted a control packet the last time it was active and the corresponding data packet has been successfully scheduled (although this data packet may still be in the buffer slot.)

An active buffer slot is considered backlogged if it contains a data packet whose corresponding control packet failed in the control packet contention or data packet scheduling. Let η denote the number of idle nodes (active buffer slots). Clearly, the number of backlogged nodes (active buffer slots) is N−η.

Now note that the control packet contention with time-sequenced buffer in a given frame is analogous to the control packet contention with the single-packet buffer considered in Section V. In a given frame, each of the η idle active buffer slots generates a new data packet and sends a control packet with probability σ. Each of the N−η backlogged active buffer slots retransmits a control packet with probability p. Thus the expected number of successful control packets per frame M·κ, as given in Section V-B.

Next note that the time-sequenced buffering does not interfere with the data packet scheduling as described in Section IV and analyzed in Section V. Thus, the throughput results derived for the different operating modes in Section V apply without any modification to the time-sequenced buffer scenario.

Finally, note that the delays for the different operating modes as derived in Section V are scaled by the propagation delay of τ frames when considering the time-sequenced buffer scenario. Specifically, for the AWG-PSC mode, there is a delay component of τ frames for the initial control packet. In addition, there is a delay component due to control packet retransmissions (if control packet contention or data packet scheduling failed.) This second delay component is the expected number of backlogged nodes N−E[η] divided by the expected throughput Z_{A}+Z_{P} (similar to the case analyzed in Section V-D), but is now scaled by the propagation delay τ. Thus, the average delay is

$$Delay = τ \cdot ( 1 + \frac{N - η}{{Z}_{P} + {Z}_{A}} )$$

in frames, where we make again the reasonable approximation E[η]≈η.

In analogous fashion, the average delay for the PSC-only mode is

$$\text{Delay} = τ \cdot ( 1 + \frac{N - η}{{Z}_{P} + {Z}_{A}} )$$

As discussed in Section V-F, in the AWG-only mode with wavelength reuse, there are two additional delay components, cyclic control transmission delay I_{del} and scheduling delay if the data packet is not immediately transmitted. These two delay components are not affected by the propagation delay. Thus, the average delay (in frames) for the AWG-only mode with spatial wavelength reuse is

$$\text{Delay} = τ \cdot ( 1 + \frac{N - η}{{Z}_{P}} ) \text{frames} .$$

C. Numerical and Simulation Results

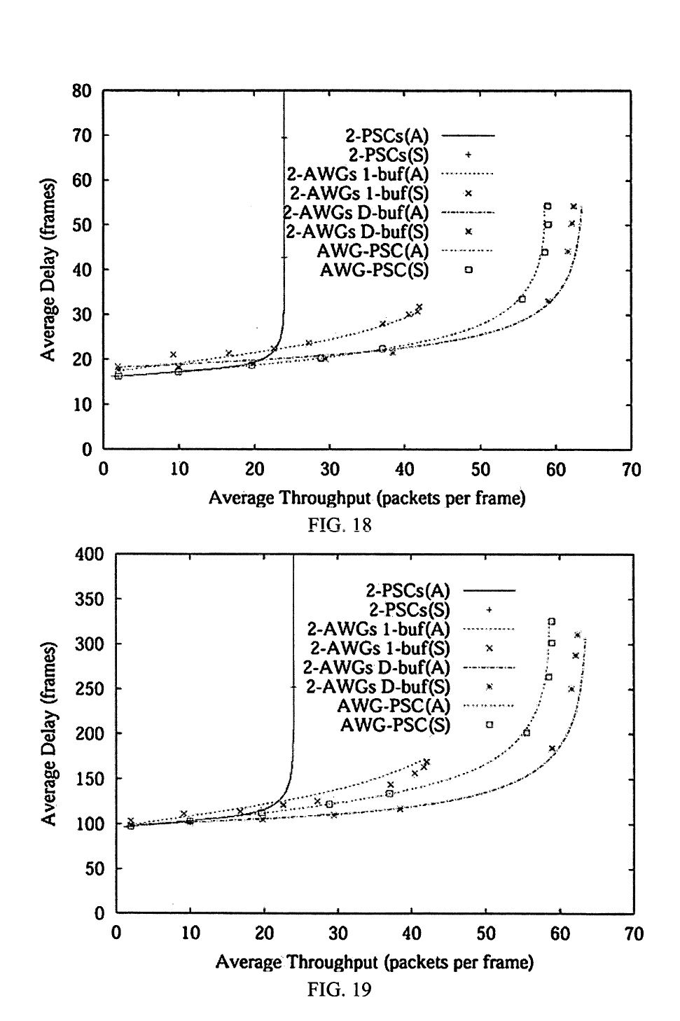

In this section, we examine the throughput-delay performance of the two-device networks, AWG∥PSC, AWG∥AWG, and PSC∥PSC with time sequenced buffering. For the AWG∥AWG network we consider both single buffer and D-buffer operation. For the D-buffer operation we combine the time-sequenced buffering introduced in this appendix with the D packet buffers analyzed in Appendix B, for a total of D (τ+1) packet buffers at each node of the AWG∥AWG network with D-buffer operation. (Each node has only τ+1 packet buffers in the other considered networks.) Throughput we consider the AWG∥AWG network with control packet contention on both AWGs and a scheduling window of D frames (the PSC∥PSC and AWG∥AWG networks have a scheduling window of one frame.) The numerical and simulation results are presented for one-way end-to-end propagation delays of τ=4 frames, τ=16 frames, and τ=96 frames in FIG. 17, FIG. 18, and FIG. 19, respectively. We observe that the throughputs for all of the networks are independent of the τ values and are the same. The throughput for the three networks are also the same as the throughput for a propagation delay of less than one frame, see FIG. 13. Thus, the time-sequenced buffering allows us to effectively utilize the full transmission capacity of the networks even for large propagation delays. Also it allows us to apply the probabilistic analytical model developed in Section. V.

We observe that the AWG∥PSC network has smaller delay compared to the AWG∥AWG network for small τ. As the propagation delay τ increases the gap in delay between the AWG∥PSC network and the AWG∥AWG network becomes smaller. For small τ, the relatively larger delay for the AWG∥AWG network is due to the cyclic control packet transmission. As τ increases, the delay due to the cyclic control packet transmission becomes less and less dominant. We also observe that the single-buffer AWG∥PSC network gives larger throughput than the single-buffer AWG∥AWG network. The throughput of the D-buffer AWG∥AWG network is somewhat larger (at the expense of more complexity) than the throughput of the single-buffer AWG∥PSC network. Overall, the results indicate that the low-complexity AWG∥PSC network gives favorable throughput-delay performance for realistic propagation delays.

1. A wavelength division multiplexing communications network comprising:
an arrayed-waveguide grating;
a passive star coupler coupled in parallel with the arrayed-waveguide grating; and
a plurality of nodes coupled to the arrayed-waveguide grating and the passive star coupler.

2. The communications network of claim 1 wherein each node is coupled to the arrayed-waveguide grating with a tunable transmitter and a tunable receiver.

3. The communications network of claim 1 wherein the arrayed-waveguide grating and the passive star coupler are both functional during normal operation of the network.

4. The communications network of claim 1 wherein the network is configured to spatially reuse all wavelengths at the arrayed-waveguide grating ports.

5. The communications network of claim 1 wherein the network is configured to use the wavelengths on the arrayed-waveguide grating continuously for data transmission.

6. The communications network of claim 1 wherein the transmitter and receiver are tunable and provide any-to-any connectivity in one single hop.

7. The communications network of claim 1 wherein each node is equipped with an additional transmitter/receiver pair that is coupled to the passive star coupler.

8. The communications network of claim 1 wherein the passive star coupler is configured to transport broadcasting control information and overflow data traffic that cannot be accommodated on the arrayed-waveguide grating.

9. The communications network of claim 1 wherein the network can operate in any of:
a first mode wherein both arrayed-waveguide grating and passive star coupler are functional;
a second mode wherein the passive star coupler has failed;
and a third mode wherein the arrayed-waveguide grating has failed.

10. A method of operating a wavelength division multiplexing communications network communications network, the method comprising:
coupling a passive star coupler in parallel with an arrayed-waveguide grating; and
coupling a plurality of nodes to the arrayed-waveguide grating and the passive star coupler.

11. The method of claim 10 further comprising operating the network in an AWG-PSC mode wherein the passive star coupler and the arrayed-waveguide grating are both functional.

12. The method of claim 10 further comprising operating the network in a PSC-only mode wherein the passive star coupler is operational when the arrayed-waveguide grating fails.

13. The method of claim 10 further comprising operating the network in an AWG-only mode wherein the arrayed-waveguide grating is operational when the passive star coupler fails.

14. The method of claim 10 wherein the plurality of nodes includes a source node and a corresponding destination node and prior to transmitting a given data packet the source node sends a control packet to the corresponding destination node.
